(19) United States
(12) Patent Application Publication
(10) Pub. No.: US 2003/0005823 A1
(43) Pub. Date: Jan. 9, 2003

(54) Modular mass transfer and phase separation system

(76) Inventors: Ron Le Blanc, Glanmire (IE); Steve Licht, Wilson, NY (US)

Correspondence Address: MORRISON & FOERSTER LLP, 3811 VALLEY CENTRE DRIVE, SUITE 500, SAN DIEGO, CA, 92130-2332, US

(21) Appl. No.: 09/837,646

(22) Filed: Apr. 17, 2001

(51) Int. Cl. B01D 47/00

(52) U.S. Cl. 95/149; 96/243

(57) ABSTRACT

A modular mass transfer and phase separation system for a fluid comprising a mass transfer component and a second component from which the mass transfer component is separable by mass transfer. The system has a first stage and at least one later stage each stage comprising: co-current contacting means for co-currently contacting at least two fluid streams to effect mass transfer of the mass transfer component and phase separation means for separating phases from the co-currently contacted fluid streams. The stages are in fluid communication so that at least two fluid stream which has been separated by phase separation in the early stage is communicable for co-current contacting and for phase separation in a later stage. At least one fluid stream which has been separated by phase separation in a later stage is communicatable in a counter-current direction for co-current contacting and for phase separation in the early stage. The system may be modular. The invention also relates to a method of effecting mass transfer and phase separation utilised in the above system.

### TECHNICAL FIELD OF THE INVENTION

The present invention is concerned with the separation of components using mass transfer between phases to effect transfer of at least one component between the phases. Mass transfer effect are used in many applications throughout a wide variety of technologies on large (industrial) scale to smaller scale operations such as laboratory or pilot plant scale. Mass transfer processes are used in processing industries to separate components from (fluid) mixtures of components. Industries which use mass transfer effects include the petroleum and other natural resource industries, through production industries such as the chemical industry including the pharmaceutical industry mid recovery/purification industries e.g. solvent recovery or solvent purification processes for example using distillation. The present invention is pertinent to many applications in which mass transfer effects are utilised.

### BACKGROUND OF THE INVENTION

One main use of mass transfer processes is for separation of one or more components from a fluid mixture of components. Mass transfer may be used to separate a desired component from other components, or in enriching a fluid stream in one or more components by removal of one or more other components. Enrichment may be achieved by a process known as contacting.

It will be appreciated that in refining operations, chemical/pharmaceutical operations, solvent recovery operations and other component separation or isolation operations that vast amounts of resources are expended in pursuit of the objective of the separation of components to a desired extent e.g. complete separation.

In many industries there exists a desire to separate components from fluid streams. The equipment used to effect separation includes those simply termed “a separator” in particular an “equilibrium separator” in which a fluid mixture, often a gas/liquid mixture (a two phase mixture) enters the separator and is allowed to separate under regulated temperatures and/or pressure. The gaseous and liquid phases are kept as close as possible to the state where they arc in equilibrium with each other so that mass transfer between the phases can occur to the greatest extent i.e. a component in one phase can transfer into the other in the most efficient way possible. Separation systems have long been known for lack of efficiency drawbacks in particular those encountered in separation of components from multi-component fluids in particular multiple components in a single fluid. Such separations have proved difficult using conventional separation systems.

Known for separation of components, particularly those within a multi-component phase is a column or lower often used for example in distillation or contacting type separations. Distillation is a term often used to refer to the separation of two or more fluids using a difference in volatilities between the fluids to force the separation. Included within the term “distillation” in the present invention are in particular (but not limited to) fractionation, reactive distillation, stripping, enriching, regeneration, desorbing, (with heat addition), degassing (with heat addition) processes. These may also be referred to as distillation-type operations or processes. Contacting includes in particular those processes where contacting is with a liquid such as in particular (but not limited to) scrubbing, absorbing, adsorbing. (While adsorbing usually applies to a solid adsorbing a liquid a slurry of a solid may be used for adsorption). These may be referred to as contacting-type operations or processes. Other types of contacting processes where contacting is with a second fluid gas stream include certain degassing processes, evaporative cooling, and certain desorbing processes.

A distillation column is typically made up of two sections the first being the section below the feed point which is the stripping section and the section above the feed which is called the rectifying section. The rectification section is used to concentrate the more volatile fluid whereas the stripping section concentrates the less volatile fluid. In a typical distillation system a series of horizontal trays are provided, each of which is spaced from the next along the vertical lower so that each form a stage on which separation can occur. Another tower system is a packed tower where the density of packing determines the amount of packing needed to achieve an equilibrium stage. The most usual arrangement of both systems is the provision of a heat source at the base of the tower and most usually a condenser at the top of the tower. The heater boils liquid at the bottom of the tower which turns at least some of the liquid to vapor. Mass transfer effects occur at each stage along the column so that separation of components between the liquid and gaseous phases occur. Liquid moves downwardly (under gravity) through the column while gas moves upwardly. The counterflow movement (usually vertically upwardly and vertically downwardly) of the phases is often referred to as counter-current due to the contra-flow path of the liquid and the vapour. The more elevated stages (those upstage and close to the top of the tower) contain higher relative amounts of the more volatile component(s) being taken off as a vapour while the less elevated stages (those downstage closer to the base of the tower) have higher relative concentrations of the less volatile component(s) being taken off as a liquid phase. Mass transfer generally involves separation of components from one fluid stream to another e.g. liquid to vapour, vapour to liquid, liquid to liquid or liquid to solid (for example in the case of a slurry) transfer.

Other well known configurations of separation equipment include those known as “contactors”, “absorbers” or “regenerator,”. A contactor operates to effect mass transfer between phases and would most usually include a “contact” or secondary fluid feed. The primary fluid feed contains at least some of the components to be separated. The secondary fluid feed contains at least one component which when contacted with the primary feed enriches the primary feed by removal of an undesired component in the primary teed by mass transfer between the feeds This is most usually achieved when two fluids typically a gas and a liquid are contacted together so that a component from the gas stream is absorbed into the liquid stream. This can be done in either a trayed or a packed column and would normally be a continuous operation. In contacting typically there is no heat added or removed. Contacting or absorbing is often considered to be the reverse of stripping or regenerating. The feeds are both fluid feeds e.g. both liquid feeds or gas/liquid feeds. Alternatively the contacting step may use chemical properties or other physical properties to effect the necessary separation One example of a contactor is the type used in the recovery of naturally occurring fluid energy resources such as in petroleum or natural gas recovery. For instance in the recovery of natural gas it is known to use an amine contacting step as certain amines have a high affinity for H₂S and CO₂—common impurities in natural gas. In the contactor it is most unusually a liquid (in most cases liquid amine)which is fed counter-currently to the natural gas stream. Concentration and equilibrium forces combine to effect mass transfer of H₂S find CO₂ from the natural gas stream into the amine stream. An alternative fluid which is used typically for the removal of water is a glycol. The alternative term absorber for a contactor is usually used to refer to a specific type of contactor where absorption occurs for example in the natural gas process described above the term stems from the “absorption” of the impurities into the amine stream.

Another configuration of separation equipment is that often referred to as a “stripper”. A stripper is a form of regenerator. Like the other configurations of separation equipment set out above a stripper effects separation of phases using a difference in volatilities to achieve separation. A stripper is usually so named as a more volatile phase of the mixture is stripped from the fluid. In the stripper configuration heat is usually needed to drive separation. Subsequent cooling is not always required as a vapour product may be required.

Other configurations of mass transfer and phase separation equipment which effect separation of at least two components using a difference in volatilities to effect the separation will also be known to those skilled in the art. One configuration of rectifier is that where a more volatile component of the mixture is to be enriched in the vapour phase by contacting with a refluxed liquid.

Many types of separation units are known. Those known include decanters which operate by separating two immiscible liquids of sufficiently different densities. Also known are separators which utilise centripetal/centrifugal forces to effect separation. Examples include cyclone separators and centrifuges.

The tower configurations of many of the processes described above are of large dimensions typically of the order of tens of meters high for example 20 to 30 meters high. Thus the configurations are obtrusive as large scale plant equipment as they often obstruct the field of view—making them aesthetically unpleasant. Furthermore the cost of building, transporting and erecting the towers are relatively high due at least in part to the dimensions and mass of the equipment and materials needed.

Tower configurations are also known to be relatively inefficient with respect to the large amount of space occupied by the equipment, the large mass of the equipment and in terms of cost of the equipment used.

The inefficiency in the tower systems results from a number of perceived factors which include

(i) Mass transfer is conducted inside a tower of relatively large diameter (as compared for example to the diameter of the inlet and outlet piping). Progress through the tower is thus at a velocity substantially less than the velocity at the point of entry into the tower. The decrease in velocity is necessary to allow counter-current mass transfer and gravity separation of liquid and vapour to occur at each stage along the tower. At high velocities vapour may carry with it liquid thus decreasing the efficiency of separation.

(ii) The counter-current flow which typically takes place in a tower may cause undesirably long residence time.

(iii) While it may be achieved with difficulty and/or substantial extra expense (including for example additional unit operations or processing steps such as) the addition of, or removal of, heat at any given stage within the tower is not conventional.

(iv) It is difficult to regulate to a desired extent the addition or removal of any given phase at any given stage along the column.

(v) Efficiency per unit of volume occupied by the system is not very high.

UK patent no. 1,531,537 and U.S. Pat. No. 4,752,306 both describe degassing equipment for removal of oxygen from sea water. Both patents describe displacing the oxygen utilising nitrogen by at least partially replacing the oxygen in the sea water with nitrogen gas. The methods described employ inert gas (nitrogen).

### OBJECT OF THE INVENTION

The object of the present invention is to provide an effective and efficient separation system which utilises mass transfer effects. Ideally the system would he configurable so as to have lesser dimensions than typical conventional configurations for effecting mass transfer. It is desirable that the configuration would have an overall height of less than about four meters. Also a system which could provide increased efficiency would be useful as would one which is relatively inexpensive to manufacture and which is reliable in use. Particularly desired is for example a system which could be made as an add-on unit for example in the form of a self-contained unit which can be retrofitted to an existing facility. In particular it is desirable if the assembled system could be transported by road without being considered an oversized load. For example the system could be provided in a transport module such as for example one which has typically the same dimension as a freight container of the type transported by trucks. The system of the present invention satisfies these objects.

### SUMMARY OF THE INVENTION

The present invention provides a mass transfer and phase separation system for a fluid comprising a mass transfer component and a second component from which the mass transfer component is separable by mass transfer the system comprising:

a first stage and at least one later stage each stage comprising:

co-current contacting means for co-currently contacting at least two fluid streams to effect mass transfer of the mass transfer component and phase separation means for separating phases from the co-currently contacted fluid streams;

the stages being in fluid communication so that at least one fluid phase obtainable by phase separation in the first stage is communicatable (in a forward flow direction) for co-current contacting and for phase separation in a later stage and at least one fluid phase obtainable by phase separation in a later stage is communicatable (in a contraflow direction) for co-current contacting and for phase separation in the first stage

It will he appreciated by those skilled in the art that the above system is configurable with dimensions within the desired limits described above. The mass transfer component and the second component are both components of a fluid. The person skilled in the art will know how to choose the it least two fluid streams so as to achieve the desired mass transfer effects. The fluid which undergoes mass transfer and phase separation at each stage is the fluid mixture of the at least two fluid streams which are co-currently contacted at each stage. In particular a system of the present invention may be provided in an assembled configuration for example allowing ease of attachment to existing plant equipment. It will be evident to those skilled in the art that the feed from the first stage (or “downstage stage”) to a later stage (an “upstage stage”) and the return feed from a later upstage stage need not involve the same later stage. As long as one fluid has been through two stages and is recycled to an earlier stage the separation desired is achieved. In one configuration at least three stages are provided. At least two of the stages are configured as described above. The third (or each additional) stage may comprise any mass transfer and/or separating means but desirably has the same configuration as the first or later stage described above.

Desirably the first (earlier) stage and the later stage(s) are each provided in modular form. This means that the system is very versatile in its implementation as will be appreciated a modular system is configurable in may conceivable ways. This compares favorably with for example a separation tower where each tray (stage) is within a single tower body and fluid travels between successive trays. In a tower it is almost impossible to reliably regulate the flow path of any phase separated at any stage within the tower.

Desirably co-contacting of the fluid streams is carried out forcibly. For example the means for currently contacting the fluid streams may be a mixing unit which is adapted to forcibly mix the fluid streams so as to achieve, mass transfer. The fluid streams move through the mixing unit in the sane direction (co-currently). Desirably the fluid streams are fed at velocity (for example by pressurising the fluid streams e.g. by pumping) to the means for co-currently contacting.

The system may also be described as being a mass transfer and phase separation system for a fluid comprising a mass transfer component and a second component from which the mass transfer component is separable by mass transfer the system comprising:

a first stage comprising;

an intake I₁ for at least two fluid streams;

a fluid conduit for communicating the at least two fluid streams to co-current contact means;

co-current contacting means for co-currently contacting the at least two fluid streams to effect mass transfer of the mass transfer component;

a fluid conduit for communicating the co-currently contacted fluid from the co-current contacting means to phase separation means;

phase separation means for separating phases from the co-currently contacted fluid streams;

a first phase outlet O₁ for a first phase separated in the phase separation means; and a

a second phase outlet O₂ for a second phase separated in the phase separation means; and

at least one later stage comprising:

an intake I₂ for at least two fluid streams;

a fluid conduit for communicating the at least two fluid streams to co-current contact means;

co-current contacting means for co-currently contacting the at least two fluid streams to effect mass transfer of the mass transfer component;

a fluid conduit for communicating the co-currently contacted fluid from the co-current contacting means to phase separation means;

phase separation means for separating phases from the co-currently contacted fluid streams;

a first phase outlet O_{L1} for a first phase separated in the phase separation means; and a

a second phase outlet O_{L2} for a second phase separated in the phase separation means;

the stages being in fluid communication so that a fluid conduit communicates fluid from outlet O₁ or O₂ to intake I₂, and a fluid conduit communicates fluid from outlet O_{L1} or O_{L2} to intake I₁.

Intakes I₁, I₂ and outlets O₁, O₂, O_{L1} and O_{L2} are described below with reference to FIG. 1 though the skilled person will understand that they could be employed in relation to each of FIGS. 2 to 4 also. These labels are used for convenience only to avoid over-repetition of wording.

One embodiment of a modular mass transfer and phase separation system of the invention comprises:

(i) at least two mass transfer and separation stages (modules) arranged so that there is provided a first stage and at least one later stage, each stage comprising:

(a) a fluid intake in fluid communication with, and for supplying fluid feeds containing a mass transfer component and a second component to a co-current contacting means in the form of a mixing unit,

(b) a mixing unit for mixing the component in the fluid feeds so as to effect mass transfer of the mass transfer component by co-current contacting;

(c) phase separation means in the form of a separation chamber for separation of fluid phases for effecting separation of at least a first fluid phase and a second fluid phase from fluid received from the mixing unit,

(d) an outlet for the first phase; and

(e) an outlet for the second phase; and

(ii) a fluid communication system arranged to communicate at least one separated fluid phase from an outlet of the first stage to the fluid intake of a later stage; and for communicating a fluid phase from an outlet of a later stage to the intake of the first stage.

Fluids include liquids and gases. The term fluid is not to be construed as limited to a single component fluid(s) for example mixtures of fluids may be used as will be apparent to those skilled in the art. Particularly suited for separation by the systems of the present invention are liquid/gas fluid phases and liquid/liquid fluid phases. The mass transfer component(s) may form the fluid phase being separated or may be separable with a fluid phase with which it is (they are) associated or may be separable from a fluid phase with which it becomes (they are) associated during mass transfer processes (for example in a contacting process). The stages (or modules) may be arranged separately of each other. They can thus be located apart from each other for example spatially arranged to fit a desired location. They may be connected in series. A separated fluid phase is most usually mixed together with a second fluid feed co-currently in the mixing unit. Co-current contact flow of fluid occurs in the mixer. Good interface between the fluids is achieved and thus effective mass transfer can take place. The co-current nature of the contact allows high velocity and turbulent mixing resulting in rapid mass transfer. The stages (or modules) may be spaced apart horizontally. The trays in a tower may only be spaced apart vertically. A fluid feed containing the components to be separated may be fed in to the system at any desired point. The fluid feed could, for example, be fed into the fluid intake for one of the stages (or modules).

It will he apparent to those skilled in the art that the mixing unit is operable under conditions suitable for mass transfer. Operating parameters (such as temperature etc) suitable for any particular mass transfer process may be selected. Also the separation chamber is operable under conditions suitable for separation of fluid phases and again the person skilled in the art will know the operating parameters to select to effect the desired separation.

It will be appreciated by those skilled in the art that the transfer of fluid between stages (or modules) need not be done directly. Many intermediate processing steps such as reacting steps or additional mass transfer and/or phase separation steps or non-processing steps such as heating, cooling, pressurising, pumping, etc. could take place between modules. Transfer involving processing steps in particular could be considered indirect. Provided that at least one fluid stream has been processed by at least two modules and at least one fluid phase separated by the later module is returned to an earlier module (for co-current contacting there) whether directly or indirectly, the system of the present invention is achieved. Additional stages, whether or not having the same equipment components as the stages of the systems of the present invention described herein may be added to give any desired system configuration. Additional stages may include partial reboilers, partial condensers or one or more separation trays.

A particular construction of modular mass transfer and phase separation system for a fluid containing the separable components which is desirable, is the system wherein at least two separate mass transfer and separation stages (modules) are connected in series so as to provide a first mass transfer and separation stage (module) and at least one later mass transfer and separation stage (module); the fluid intake for the first stage being in fluid communication with one of the fluid phase outputs from at least one later stage so that a fluid phase from a later stage is fed into the fluid intake for the first stage; the fluid intake for a later stage being in fluid communication with a fluid output from the first stage so that fluid from the first stage may be fed into the fluid intake of a later stage. Connection in series includes stages each of which receive a fluid phase from an earlier stage and each of which passes a fluid phase to a later one—excepting the first and last stage in the series.

It will be appreciated by those skilled in the art that the configurations of the system of the invention described above will allow for co-directional feed into a first stage, for instance, where the feed into a stock fluid feed to a first stage is combined with a fluid phase returned from a later stage. This is especially significant as the requirement for slow velocity through the separation unit is no longer necessary making the process time efficient. The system has as a feature counter-current fluid phase transfer in so far as a separated phase from a later stage may be returned to an earlier stage. The return of this particular phase is counter-current as compared to the general progressive movement (“forward flows”) of fluid from early stages to later ones.

In certain configurations of the system of the present invention a pressure increase across the system may be achieved. Furthermore the residence time within the system may be reduced as compared to the tower configuration. In contrast to the lower configuration the stages (modules) may be isolated each from the next so that input to a stage (module), output from a stage (module), or transfer between stages (modules) may be regulated con a stage by stage or, in modular form, a module by module basis. Movement of fluid to a stage, from a stage, or between stages is thus configurable as desired into the system. This gives enormous versatility to systems of the present invention.

While the features of the modules within the system of the present invention have been described separately it will be apparent to those skilled in the art that a modular unit comprising a unitary piece of equipment could have all or a number of the features incorporated therein, as distinct from providing two or more separate pieces of equipment to achieve the same end.

The stages (also referred to herein where appropriate as modules or cells) of the system of the present invention may be provided sequentially in series and in a configuration which achieves the desired separation. Alternatively one or more additional pieces of equipment may be added to the configuration as is appropriate for the task in hand and as will be appreciated by the person skilled in the art.

The system of the present invention may be used in conjunction with or substituted as part of a known mass transfer and separation configurations, including those described above, as will be apparent to those skilled in the art.

It will be apparent to the person skilled in the art that heaters, coolers, heat exchangers, additional intakes, outlets, pumps, valves, process control systems etc. can be provided in the configuration just described as is appropriate. In this way additional streams can be added or removed at desired points. Heat can be added or removed as desired. Suitable equipment can be provided for supply, transfer etc. of feeds or separated phases. In distillation applications it is desirable that at least one heat (temperature) regulator is provided. For example one or more coolers and/or one or more heaters may be provided. The regulator is employed to regulate temperature to cause or control (efficient) separation of the phases. As stated the regulator(S) can be provided at any point in the configuration.

In one simple configuration there is provided two mass transfer and fluid separation stages, in particular a first mass transfer and separation stage and a second later mass transfer and separation stage; the fluid intake for the first stage being arranged for fluid communication with one of the fluid phase outputs from the second stage so that a fluid phase from the second stage is fed into the fluid feed for the first stage; the fluid intake for the second stage being arranged for fluid communication with one of the fluid outputs from the first stage so that fluid from the first stage may be fed into the feed stream for the second stage.

The terms “downstage” as used herein is a relative term which is used to refer to a stage (module) in the process which is earlier in the series than a subsequent upstage (later) one. The term “upstage” as used herein is a relative term which refers to a stage (module) in the process which is later in the series than an earlier downstage one. Usually one phase which has been output from a downstage stage or downstage module will (possibly with intermediate processing) feed into an upstage stage or upstage module.

It will be appreciated that many modifications to the configurations of the invention described herein may be made, in particular by way of provision of one or more additional mass transfer and separation stages (modules). In one configuration each stage (module) is configured so as to represent an equilibrium stage in the process. In this way each stage or module could be considered to be equivalent to a stage in a separation column for example a distillation column. Equilibrium is achieved to the maximum possible extent in the mixer. The more intimate the mixing achieved the closer each module comes to being a theoretical 100% equilibrium stage. The skilled person will know, based on the appropriate calculations, the number of stage or modules required in any particular configuration to achieve the desired separation. If stage efficiency is only 50% then twice the number of theoretically required stages will be actually required for the separation. For example if 6 theoretical stages are calculated as being necessary, where stage efficiency is 50%. 12 actual stages will be required. In general the system of the invention requires less stages (being more efficient) than for example an equivalent tower arrangement.

Separation occurs in the system of the present invention stepwise in each of the stages (modules). Intimate mixing to achieve the desired extent of equilibrium is also carried out on a stepwise basis.

In one configuration at least three stages (modules) each stage having the configuration described for stages of the system of the present invention are provided in particular an n^{th} stage and at least one other stage n+r and at least one stage n−s, (where n is an integer greater than or equal to 2 and r and s are each, independently of each other, an integer greater than or equal to 1; provided that n−s is at least 1), are arranged in a series so that a fluid phase output from a stage n−s or stage n is fed to a stage n+r and a fluid phase output from stage n or a stage n+r is fed to a stage n−s. In this configuration each of the stages (after the first stage) receives a fluid phase from at least one earlier stage. If a later stage does, not receive a fluid phase from an earlier stage it may not, depending on the particular arrangement, be considered as part of a system of the present invention.

For example at least three stages or modules namely a first, second and third stage or module wherein n=2, r=s=1 are arranged in series with the second stage or module (the nₜₕ stage or module) upstage of the first stage or module (the n—s stage or module) and, the third stage or module (the n+r stage or module) upstage again from the second stage or module. A stock feed containing components separable as phases may be fed into the first stage or module or indeed at any desired stage. The stock feed may represent any feed for example solvent for recovery, hydrocarbons for fractionation etc. The stock feed intake may be mixed (intimately contacted) with a separated fluid phase from the third stage or module while a fluid phase output from the first stage or module is fed as input into the second stage or module. In one arrangement where the stages are arranged sequentially in series, any given stage n receives a separated fluid phase input from a stage n−s and a separated fluid output from stage n is provided to stage n+r.

Suitably the stages (modules) are arranged sequentially in a series of at least three stages (modules) so there is a stage (module) n (n is an integer greater than or equal to 2), stage (module) n−1 downstage from the stage (module) a, and also a stage (module) n+1 upstage from the stage (module) n. A fluid phase output from stage n will be provided to stage n+1. A fluid phase output from stage n or stage n+1 may be fed to the fluid intake for stage n−1.

The (modular) system of the invention may be used for separating components (e.g. as fractions) from a stock fluid containing at least two separable components. The stock fluid may be fed into a first (usually downstage) stage together with at least one phase from an upstage stage. This may done under pressure (velocity) so that the entire feed is pressurised and the velocity of the resultant mixture is relatively high through the system as compared to the corresponding velocity through a tower.

The pressurised fluid fed to a downstage stage may be a naturally occurring pressurised fluid for example a naturally occurring pressurised petroleum or gas reserve. Alternatively the pressure may be applied to the fluid stream by any suitable means. Creation of the desired pressure may be achieved in many different ways and one or more appropriate methods for any given application. Most usually a pump would be used. Typically the fluid would be pressurised to a pressure in the range from about 0.1 kPa to about 100,000 kPa. One desired range which is particularly useful is a pressure from about 10 kPa to about 10,000 kPa. At such (pumped or naturally occurring pressures it is usual to have the fluid travel at a velocity of from about 0.1 ms^{31 1} to about 300 ms⁻¹ more usually from about 0.5 ms⁻¹ to about 100 ms⁻¹ (along the direction of the fluid intake).

The mixing unit is most usually selected to create an intimate mixing of fluid streams or of two or more components within a fluid stream. Mass transfer is best effected with relatively intense contact between the fluid streams. Accordingly, to achieve theoretically complete mass transfer (100% efficient process) infinite contact time between the fluid phases is necessary. In the present invention therefore the use of mixing units or mixers which cause most intimate contact are desired. The skilled person will know of many types of mixing units. Examples of mixing units include those termed static mixers, agitators, sprayers, sonicators, and ejectors (eductors). The terms ejector and eductor are used interchangeably with reference to the present invention. Particularly preferred are those mixers which can utilise energy in a pressurised fluid to effect mixing.

The term “static mixer” refers to a mixer where a baffle or baffles provide (fluid flow) interference for materials passing through the mixer. This causes a cuttings rotation and recombination of fluid resulting in mixing. The term “static” is employed to refer to the arrangement within the mixer where the baffle(s) are not mechanically driven and usually take the form of one or more fixed baffle(s) which do not move to any substantial extent and are thus termed static. Mixing is best achieved in such systems by utilising, a pressurised fluid or fluid(s). Desirably the mixer is vertically orientated (rather than horizontally orientated) so that the direction of travel of the fluid (and thus mixing) is in the vertical direction. The vertical orientation may allow for better mixing as two phase flow may separate more easily in a horizontal orientation. Horizontal arrangement may allow for height advantages. Pressure in this context may refer to fluid travelling at velocity rather than to pressure above atmospheric pressure. Forcing the fluid(s) through the mixer results in mixing. The baffle(s) may be provided by one or more mixing elements. The mixing element is formed by a series of plates or vanes designed to cause shear and other forces to act on the fluid causing turbulence in the fluid and resulting in intimate mixing. The plates are arranged to be presented to the fluid flow so as to achieve effective mixing. It is normal to provide different arrangement of plates in a mixing element so that plates are differently shaped and oriented differently to each other. The mixing element can thus be considered a series of interconnected vanes causing intersecting fluid flows and homogeneity in the fluid. Vanes may be of a crimped or corrugated shape. Suitably the mixing unit is adapted to be positionable at, or close to, the feed intake of the module in question.

A static mixer which may be employed in a system of the present invention is typically of relatively small dimensions so that for instance it is usually not significantly greater in size that for example a fluid feed pipe. In one desired configuration of mixing unit the static mixer is formed by providing at least one mixing element within a piece of piping. This may be achieved by placing one or more mixing elements of a diameter suitable for insertion in the pipe, within the pipe. Typically the, or each, mixing element is of a diameter which gives a snug fit in the pipe. The mixing element(s) may held in place in the pipe by any suitable means, for example by provision of a collar on at least one mixing element which in turn can be fixed to the pipe. As in most cases piping tends to be tubular in shape it is usual that the mixing elements are shaped accordingly. It will be appreciated however that the shape of the mixing unit is not of significance so that any desired shape can be used.

An alternative or additional mixing unit which is particularly useful in the present invention is referred to herein as al “ejector” (eductor”). The term “ejector” is used herein to refer to an apparatus which has an inlet for intake of fluid, all outlet ejector nozzle through which the fluid may be ejected as a spray usually a conically shaped spray. The ejector is thus analogous to an injector for example of the type used in fuel injection systems. It will be appreciated that a fluid having a mixture of components that pass through such an ejector will be finely dispersed allowing for mass transfer to occur between phases in the mixture. The mass transfer effect may be enhanced by subsequently passing the dispersed fluid through an additional mixing unit such as the static mixer described above. It will be appreciated also that an ejector is a relatively small piece of equipment and can be easily added to the system of the present invention without increasing the bulk of the system. In particular the ejector, in common with the static mixer can be incorporated into piping at the desired location. Placing an ejector (or a static mixer) within an existing piping docs not result in any substantial increase in the bulk of the system. The low pressure created by a pressurised fluid fed to the ejector can be used to stick in another fluid if desired. Increasing the pressure across the ejector can thus be used to increase pressure across the system.

A very useful type of separation chamber which may be used in the present invention is one which effects separation using centripetal/centrifugal forces. Many of these devices can effect separation based on differing densities between the phases being separated. Preferred is a cyclone type separator which in particular can utilise the motive force in a fluid traveling under pressure (at velocity) to effect separation of phases within the fluid. A cyclone type separator can receive fluid travelling at velocity from the mixing unit directly. If the velocity of the fluid from the nixing unit is sufficiently high the desired separation may be achieved by utilising the velocity of the fluid to effect the separation within the cyclone separator. This is most easily achieved effectively where there are sufficient differences in densities between the two phases. Such separators are particularly useful for separation of two or more liquid phases or at least one each of a liquid phase and a gaseous phase. In particular it is desired that the cyclone separator comprises:

(i) a vessel with a vessel side wall, the vessel having an interior circulatory surface, and a first end and a second end,

(ii) a fluid intake for communicating pressurised fluid into the interior of the vessel tangentially to the interior circulatory surface so that the fluid whirls along (about) the interior circulatory surface of the vessel creating a vortex and effecting separation of at least two phases under the forces of the vortex;

(iii) an outlet for a first phase arranged to collect a first phase separated in the vortex from the fluid and to communicate it to the exterior of the vessel; and

(iv) an outlet for a second phase arranged to collect the second phase separated in the vortex from the fluid and to communicate it to the exterior of the vessel.

The separation of phases is achieved through the centripetal/centrifugal forces which cause primarily the denser phase to spin to the exterior of the vortex and against the circulatory surface of the vessel while primarily it is the less dense phase which remains out of contact with the circulatory surface of the vessel (closer to the axis of rotation of the vortex). The effect is that primarily the denser phase can be recovered from the circulatory surface of the vessel while primarily the less dense phase continues to travel in the vortex. The denser phase can be considered to be “spun out” from the vortex.

The intake for the cyclone separator may simply be a conduit to the interior of the vessel which imparts the tangential trajectory to the pressurised fluid. In this embodiment it is normal (though not necessary) for the cyclone to be arranged in a substantially vertical configuration so that for example in separation of gaseous and liquid phases the gaseous phase collected normally exits through the top end of the vessel. The liquid normally travels downwardly to be collected toward, or at, the base of the vessel.

Alternatively the tangential trajectory may be provided by passing the pressurised fluid over one or more vanes which arc arranged in the intake to impart the desired trajectory. In this embodiment the vessel can be arranged so that the longitudinal axis about which the vortex whirls is at any desired angle, and, in one typical configuration, may be arranged substantially horizontally.

The cyclone provides a particularly effective means of separation of phases. In particular the main components of a cyclone are all non-moving parts in keeping with the objective of creating a relatively inexpensive system which is simple in construction and reliable in use.

The cyclone could for example operate with an interior circulatory surface which is formed on a separate component within the vessel. However in a simplest construction at least part of an interior side wall of the vessel forms the interior circulatory surface.

The vessel may be of any desired exterior shape provided that it has sufficient interior surface to allow a vortex to be created so as to effect separation. The interior circulatory surface may for example be a cylindrical or part-cylindrical wall, or a conical or part-conical wall. The wall need not be perfectly circular in shape and the skilled person will appreciate the amount of deviation from a circular shape which will be tolerated before the efficiency of separation suffers dramatically. Partly conically shaped circulatory structures are common in cyclone separators as are other shapes with reducing diameters along the vortex path The cyclone, can in common with other components of the system be incorporated into the system without any dramatic increase in bulk to the system. For instance the diameter of the circulatory surface can be as low as about 1 cm. It is desirable that the circulatory surface has a diameter in the range of about 2 cm to about 1,000 cm. Accordingly the cyclone can be incorporated into for example some piping without any significant change in bulk.

In one desirable configuration of cyclone separator the cyclone has an additional recirculation path for isolating and recycling amounts of the denser phase travelling with the vortex toward the outlet for the less dense phase. This ensures even better separation is achieved. This may be achieved by providing a trap for the denser phase and by recirculating the trapped fluid toward the mouth of the vortex. In one particularly simple construction a recirculation path is provided which exposes fluid isolated in the trap to the low pressure generated at the center of the vortex to suck the isolated fluid back into the vortex. The isolated fluid is thus effectively recycled without the necessity for provision of a separate recirculation mechanism. Recirculation of fluid is thus economically and reliably achieved.

In one simple construction the cyclone separator is provided with a circulatory surface formed at least in part by an interior surface of an elongate tubular element with a tubular body, a fluid intake end, and a fluid outlet end, the tubular element being spaced on at least one side from an internal wall of the vessel. The fluid is supplied tangentially (as described above) to the fluid intake end and the fluid passes in a vortex from the intake end to the outlet end. The same considerations as to shape apply to the circulatory surface of the elongate tubular element as to the circulatory surface formed by a wall of the vessel. The circulatory surface may be formed in part by an internal wall of the vessel and in part by an elongate tubular element.

A trap may he conveniently formed by providing at least one aperture in the tubular body of the elongate tubular element usually at a position toward the outlet end of the elongate tubular element. The aperture(s) provided allows for denser fluid (for example liquid) to travel out of the elongate tubular element under the influence of the centrifugal/centripetal forces. In the arrangement where fluid thus isolated by the trap is exposed to the lower pressure generated at the center of the vortex, and the isolated fluid is sucked back into the vortex to travel once again with the vortex thus effectively being recycled for effective separation. The recirculation route of the fluid may be exterior to the clongate tubular element and between it and an internal wall of the vessel. Alternatively a conduit for recirculation of the fluid to the desired point could be provided. Suitably tie fluid is returned to the intake end of elongate tubular element or to a position proximate thereto. A secondary trap may be provided to trap a fluid component of the recirculating stream. For example where the denser component is a liquid and the less dense component is gaseous then the recirculated fluid contains mostly the liquid phase with a lesser amount of the gaseous phase. Liquid in the gaseous phase could be removed by a secondary trap for example a gravity trap while the gaseous phase is more likely to be sucked back into the vortex under influence of the low pressure generated at the center of the vortex.

Indeed in the system described above where the axis about which the vortex rotates is substantially horizontal then the secondary trap may be used as the main isolation method for at least one of the phases, for example for a liquid phase.

It will be appreciated by those skilled in the art that the present invention allows for the effective transfer of heat to or from the system. One effective method of transferring heat to or from the system is by provision of a “jacket” on at least one of the mixing units of the present invention. The jacket may operate for heating, cooling or as a heat exchanger. The intimate mixing of the components in the mixing unit allows for intimate contact also with the various components of the mixing unit so that energy in the form of heat is effectively transferred between the fluid and the mixing unit.

The invention also relates to a module or unit for use in a mass transfer and phase separation system, the module comprising:

a mixing unit adapted to co-currently contact and intimately mix fluid comprising fluid components so as to effect mass transfer of at least one component in the fluid,

a separation chamber adapted to receive intimately mixed fluid from the mixing unit and to separate fluid phases from the fluid using centrifugal/centripetal forces.

The invention also relates to a method of effecting mass transfer and phase separation comprising the steps of:

(i) in a first stage co-currently contacting at least two fluid streams, the fluid streams comprising a mass transfer component, so as to effect mass transfer of the mass transfer component and separating phases from the co-currently contacted fluid streams,

(ii) in one or more later stages co-currently contacting a separated phase from the first stare or from any earlier stage with a fluid stream so as to effect mass transfer of the mass transfer component and separating phases from the co-currently contacted separated phase and fluid stream, and

(iii) transferring a phase separated in at least one later stage to the first stage for co-current contact in that stage.

The system method of the invention could be though of as employing alternately co-current contacting means and separation means with overall counter current fluid transfer.

The method of the invention can be employed in many different equipment configurations as will be apparent to those skilled in the art. The method of the invention achieves many of the desired objectives of the present invention. If the fluid stream, provided to one or more stages have a high enough flow velocity (for example if the fluid is pumped under pressure) then the pressure of the fluid flow can be harnessed to intimately mix the fluid streams. It will be apparent to those skilled in the art that the method of the invention is carried out under conditions suitable for mass transfer and separation of fluid phases. The feed fluid for any individual stage in a method or system of the intention may comprise a fluid phase separated in an earlier stage and a fluid phase separated in a later stage. The fluid feed may comprise a feed fluid not already subject to mass transfer and fluid separation processes for example a stock fluid on which it is desired to effect mass transfer and fluid separation processes. The fluid feed for any given stage may comprise a fluid which has been subject to mass transfer and phase separation processes one or more times.

The overall effect achieved is the separation of phases following mass transfer of components between phases of the feed(s) to any given stage (module).

Embodiments of the present invention are described below in more detail with reference to the drawings.

### BRIEF DESCRIPTION OF THE DRAWINGS

FIG. 1 is a schematic representation of one configuration of a modular mass transfer and phase separation system of the present invention in which the stages (modules) of the system have been configured to form part of a distillation system which may operate at atmospheric pressure,

FIG. 2 is a schematic representation of an alternative configuration of a modular mass transfer and phase separation system of the present invention in which the stages (modules) of the system have been configured to form part of a stripper or regenerator system;

FIG. 3 is a schematic representation of an alternative configuration of a modular mass transfer and phase separation system of the present invention in which the stages (modules) of the system have been configured to form part of a rectifier system;

FIG. 4 is a schematic representation of an alternative configuration of a modular mass transfer and phase separation system of the present invention in which the stages (modules) of the system have been configured to form part of a contactor or absorber system;

FIG. 5 is a perspective view of an ejector, a static mixer and a cyclone separator connected in series and forming part of a stage (module) of the system of the present invention;

FIG. 6 is a sectional view of the ejector shown in FIG. 5;

FIG. 7 is a perspective view of a mixing unit including a mixing element suitable for use in the configuration of FIG. 5;

FIG. 7a is an end view of the mixing unit of FIG. 7;

FIG. 8 is a sectional view of the cyclone separator shown in FIG. 5;

FIG. 9 is a top sectional view of the cyclone separator of FIG. 5;

FIG. 10 shows a diagrammatic representation (part-sectional) of a mixing unit which has been jacketed for heat energy transfer;

FIG. 11 shows an end view of the mixing unit of FIG. 10;

FIG. 12 is a schematic representation of a modular mass transfer and phase separation system of the present invention configured similar to FIG. 1 but providing for additional control over the amount of a second fluid that may be sucked into the ejector by increasing the stream of liquid feed to the ejector by using a recycle of liquid from within a single stage;

FIG. 13 shows the configuration of the invention employed for the purposes of the Experiments reported below;.

FIG. 14 is a graph showing the effect of pressure on the relative volatility of the cyclohexane/n-heptane mixture

FIG. 15 is a graph showing mass transfer efficiency of the static mixer configuration;

FIG. 16 is a graph showing the hydraulic characteristics of the static mixer configuration;

FIG. 17 is a graph showing the comparative mass transfer efficiency of the eductor configuration @ 4.83 psia (0.33 bar);

FIG. 18 is a graph showing comparative mass transfer efficiency of the eductor configuration @ 24 psia (1.65 bar);

FIG. 19 is a graph showing comparative hydraulic characteristics of the eductor configuration @ 4.83 psia (0,33 bar);

FIG. 20 is a graph showing comparative hydraulic characteristics of the eductor configurations @ 24 psia (1.65 bar).

### DETAILED DESCRIPTION OF THE DRAWINGS

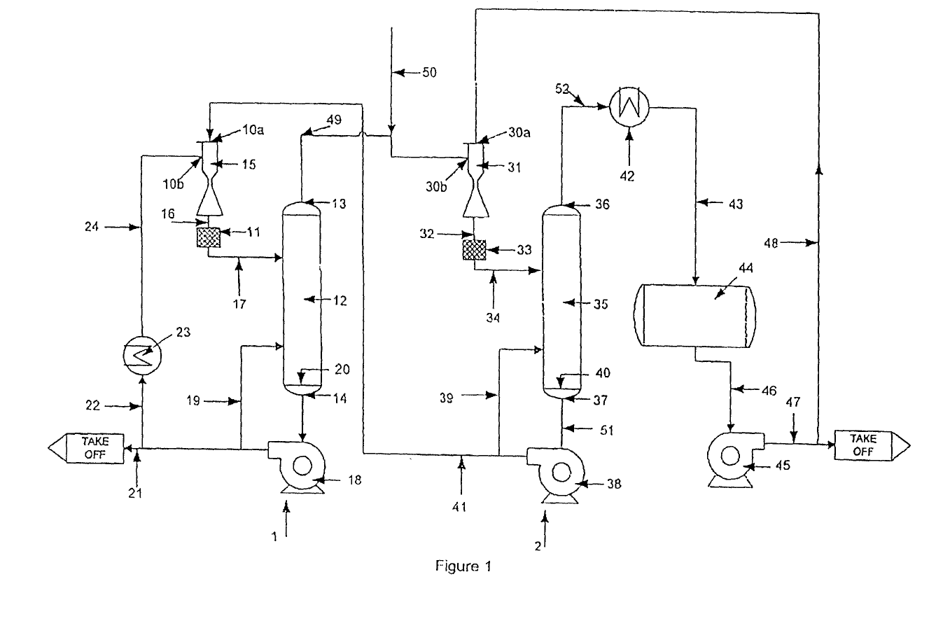

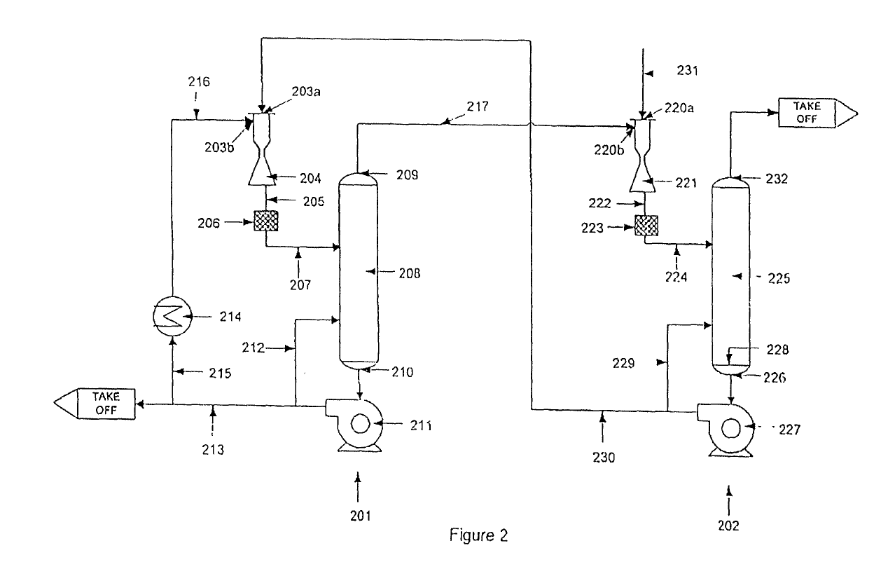

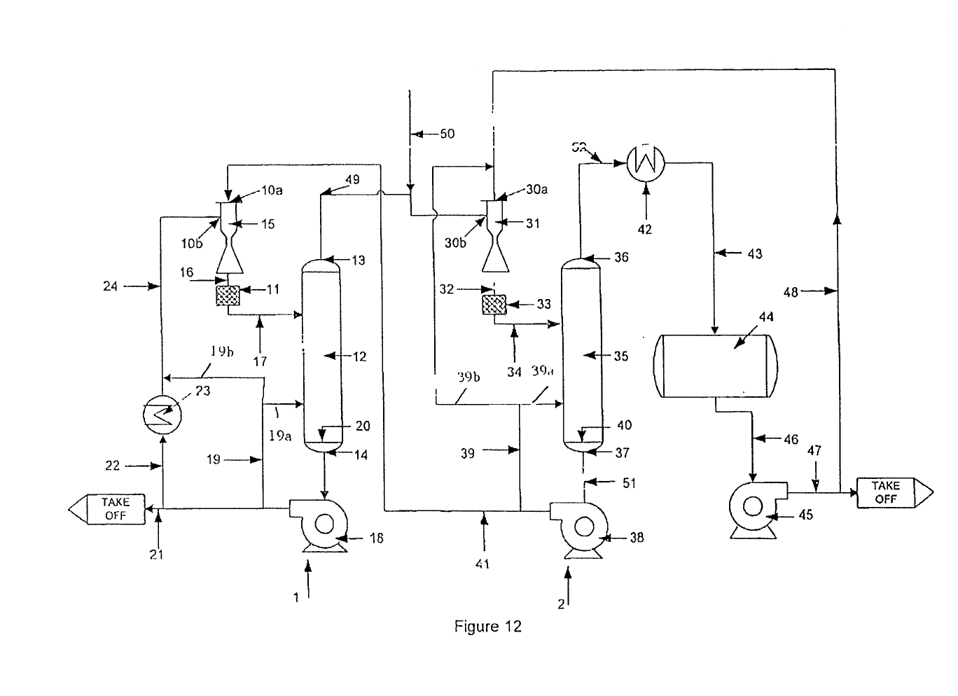

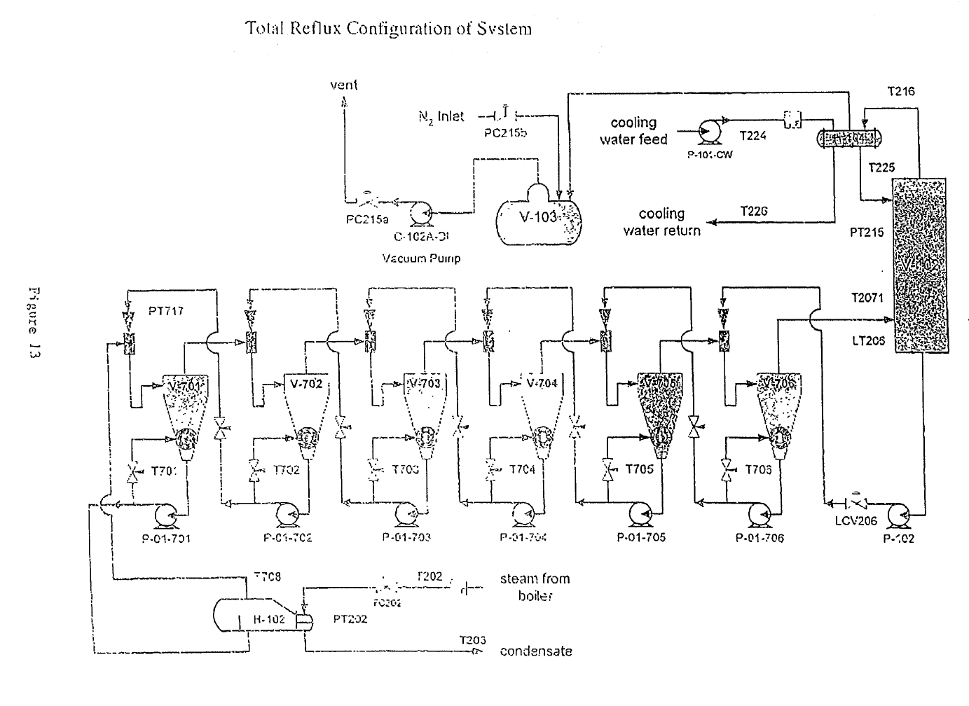

FIGS. 1-4, 12 and 13 show mass transfer and phase separation systems in the preferred modular form of the present invention, for a fluid containing components separable as two fluid phases and in particular containing a mass transfer component. In the configuration of FIGS. 1 and 12 the system is arranged for atmospheric distillation. It will be appreciated that distillation may be carried out at other pressures (higher or lower than atmospheric pressure) utilising the system of the invention. The system has two separate mass transfer and separation modules connected (sequentially) in series. The system includes a first (early) downstage mass transfer and separation stage in the form of a module 1, and a later or upstage mass transfer and separation stage in the form of a module 2. The embodiments of FIGS. 2 to 4 are also configured in modular form.

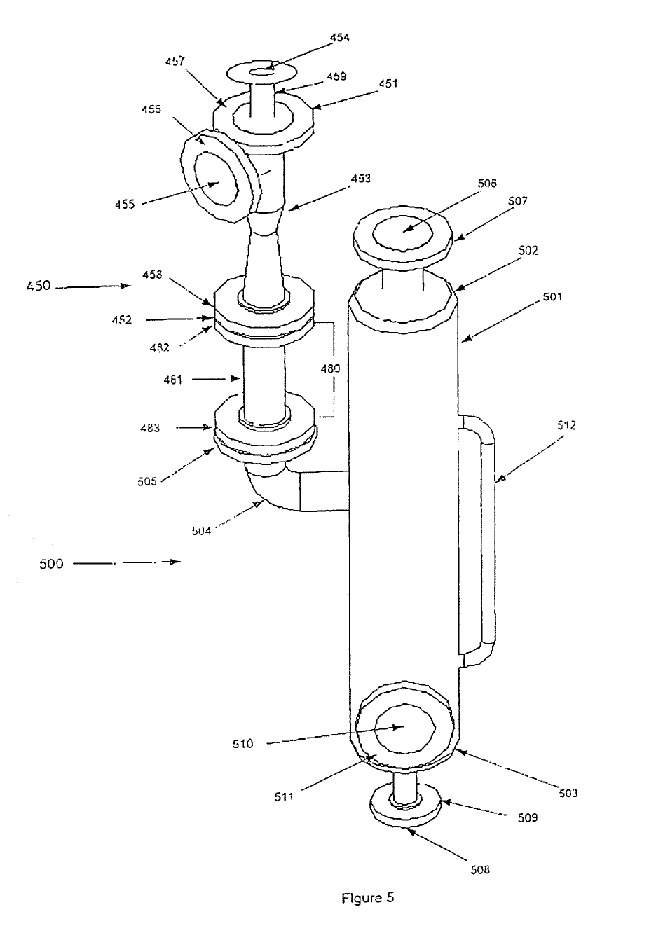

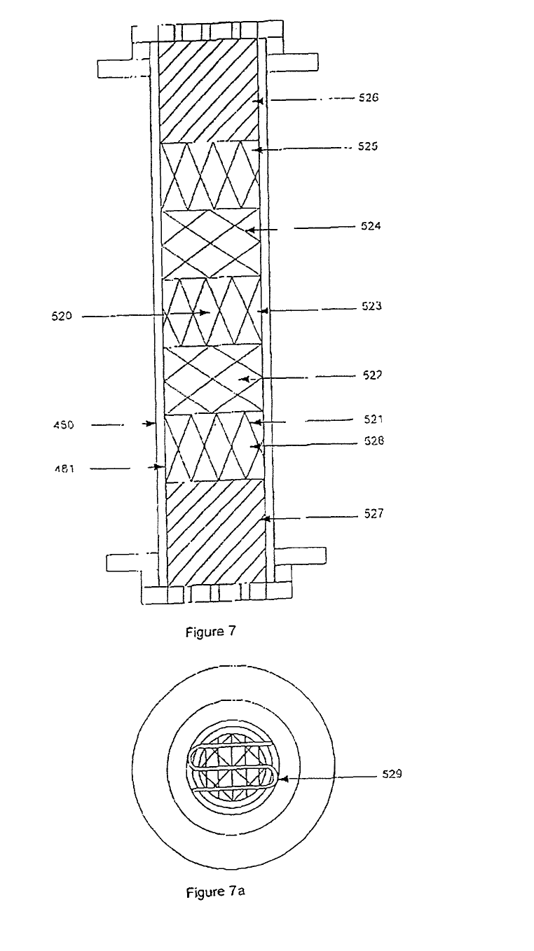

In FIG. 1 the module 2 forms a later stage than the earlier module 1. The downstage module 1 has a fluid intake in fluid communication with, and for supplying a (pressurised i.e. travelling at velocity) fluid feed to, a mixing unit 11. In particular the fluid intake comprises a first fluid intake 10a for fluid received from the second module 2, which in the embodiment is a liquid, and a second fluid intake 10b for fluid received from a reboiler 23 (described below). The intakes 10a and 10b may be commonly designated as “I₁”. The fluid received from the second module 2 is a fluid phase which has been obtained by mass transfer and fluid phase separation. The module 1 is considered to be downstage relative to module 2 as it is closer to the heat source of reboiler 23. The two fluid intakes 10a and 10b provide the separate fluids to an ejector 15 (described below). It will be appreciated by those skilled in the art that a degree of mixing is achieved by an ejector alone, but more intimate mixing may be achieved using a mixing unit (or mixer), or an ejector and mixer in combination. The mixing unit 11 is for mixing components in the pressurised fluid so as to effect mass transfer or at least one component between the fluid phases. The first module also includes a separation chamber 12 for effecting separation of the fluid phases. The separation chamber 12 in the embodiment shown effects separation using centripetal/centrifugal forces. In particular the separation chamber 12 is a cyclone separator which will be described in more detail below with reference to FIGS. 5 and 7 and 7a. An alternative mixing unit which can be used is described below with reference to FIGS. 10 and 11.

The separation chamber 12 has an outlet 13 for a first phase and an outlet 14 for a second phase. The outlets 13 and 14 may alternatively be designated “O₁” and “O₂”. An ejector 15 is provided in sequence (inline) with the mixing unit 11 so that the fluid intakes 10a, 10b feed fluid through the ejector 15, from there are passed into mixing unit 11 by means of a conduit 16 and from the mixing unit 11 via conduit 17 into the separation chamber 12. It will be appreciated that the various conduits transferring fluid represented in each of FIGS. 1 to 4 are represented only diagrammatically. In the embodiment the fluid intakes 10a and 10b are formed by part of the body of ejector 15.

Also provided is a pump 18 connected to the outlet 14 for the second phase, which can send the second phase on three different routes. The first route is a recycle loop 19 to return fluid taken off to the separation chamber 12 and which, in the case that the second phase is a liquid collected at the bottom 20, of the separation chamber 12, can ensure that the pump 18 does not run dry. Alternatively the second phase may be sent to a take-off conduit 21, or recycled via a conduit 22 to a reboiler 23 and from there via conduit 24 to the fluid intake 10a or the ejector 15. A further route for distribution of separated fluid is described below with reference to FIG. 12. All routes for the fluid may be employed at the same time so that the fluid can be sent simultaneously via all or only some of the different routes.

In the upstage or later module 2 there is provided a fluid intake 30a, 30b which is formed as part of an ejector 31. The intakes 30a, 30b may be commonly designated “I₂”. Intake 30b receives fluid output from module 1 via conduit 49 while intake 30a receives fluid returned via conduit 48. From the ejector 31 the fluid passes via conduit 32 to mixing unit 33. In the mixing unit 33 intimate mixing is effected so as to effect mass transfer of the mass transfer component. From the mixing unit 33 the fluid passes via conduit 34 to separation chamber 35. The upstage or later mass transfer and separation module 2 operates in a similar fashion to the downstage mass transfer and separation module 1. In particular the fluid intakes 30a, 30b are in communication with, and for supplying a (pressurised) fluid feed to, the mixing unit 33. The mixing unit 33 is for mixing components in the pressurised fluid so as to effect mass transfer of at least one component between the fluid phases. The separation chamber 35 effects separation of fluid phases. The separation chamber 35 has a first fluid outlet 36 and a second fluid outlet 37. The outlets 36 and 37 may be designated “O_{L1}” and “O_{L2}” as desired. The second phase is taken out at fluid outlet 37 and then travels via conduit 51 to pump 38 where there are two route options for the fluid. The first option is a recycle loop 39 which can recycle the second phase to the bottom 40 of the separator 35. This ensures that the bottom of the separator 40 can act as a sump if necessary retaining a minimum amount of the phase so that the pump 38 does not run dry.

Also provided is a conduit 41 which can, in the alternative or additionally return the fluid to the fluid intake 10a of the ejector 15. The pump 38 provides a pressurised (pumped) feed to the inlet 10a of the ejector 15 which sprays the fluid through an ejector nozzle creating a low pressure area which acts to suck in fluid from conduit 24 through inlet 10b ensuring all the fluid arrives in the static mixer 11 under pressure.

It will be appreciated therefore that the fluid intakes 10a, 10b for the downstage module 1 is in fluid communication with one of the fluid phase outputs from the upstage module 2. A fluid phase from the upstage module 2 is fed into the fluid feed for the downstage module 1. The fluid intake 30b for the upstage module 2 is in fluid communication with fluid output from the downstage module 1. Fluid from the downstage module 1 is thus fed into the feed stream for the upstage module 2.

The fluid outlet 36 passes the separated fluid via conduit 52 to condenser 42 which in turn passes the at least partially condensed phase via a conduit 43 to all accumulator 44. The accumulator 44 may be used to hold the separated and condensed phase. Alternatively, and as shown in the embodiment of FIG. 1, and if desired a conduit 46 may pass the fluid from the accumulator 44 to a pump 45. From the pump 45 through conduit 47 the fluid may be taken off as indicated (for example if the desired amount of separation is achieved) or returned by conduit 48 to the fluid inlet 30a for the ejector 31.

The main intake 50 provides a stock or main feed which contains a (mass transfer) component to he separated by mass transfer and phase separation. In the embodiment shown the phases taken off through outlets 13 and 36 from separators 12 and 35 respectively, may be both gaseous phases. The phases taken off at outlets 14 and 37 from separators 12 and 35 respectively may be each liquid phases. This would be the usual mode of operation particularly where the intake 50 provides two liquid components to be separated.

Effective mass transfer is achieved by the particular interchange of separated fluids between modules. The liquid phase returned from module 2 meets the at least partially gaseous phase from reboiler 23 and the temperature difference between these two feed streams promotes mass transfer for example a gaseous phase component travelling with the returned fluid from module 2 will tend to transfer into a gaseous feed generated by reboiler 23.

Similarly the main feed stream 50 is contacted with a gaseous output from outlet 13 so that the gaseous phase component in the main feed from stream 50 tends to transfer into the gaseous phase output from outlet 13. In the same way the liquid phases in each of feed streams tend to associate. In the embodiments of the system of the present invention described the terms liquid and gaseous are used. In general the phases separated could be described as a less volatile phase and a more volatile phase.

It will be appreciated by those skilled in the art that fluid control valves, pressure gauges and other standard equipment may be added to the systems of the present invention as desired herein. In particular it is desirable that the systems of the invention could be regulated by an automated process control system which would control fluid input to and fluid output from the system. The embodiment of FIGS. 1 to 4 described herein are exemplary of systems of the present invention and are suitable for carrying out a method of the present invention,

A very similar configuration to that of FIG. 1 is shown in FIG. 12. In the configuration of FIG. 12 the recycle lines 19 and 39 have been split so that fluid from the respective separators 12,35 can be directed via conduits 19a,39a (as in the embodiment of FIG. 1) back to the separator 12,35. Alternatively all or part of the fluid passing through conduits 19,39 can, in the arrangement shown in FIG. 12, be communicated to the respective ejectors 15,31 via conduits 19b ,39b so that it can be utilised to increase pressure. This additional flexibility of operation may be applied to all of the configurations; of the present invention. The provision of this extra recycle flexibility can in certain applications lead to an increase in efficiency of separation. At least some of the material may be sent via all three routes simultaneously or via just one or indeed via any desired combination of routes.

The increase in pressure may apply to the gas phase. The increase in pressure can be employed across each ejector (eductor). This increase can be used to compensate for example for any pressure drop associated with passing through the system e.g. in piping, static mixer, separator etc. Pressure compensation/increase is thus possible within each stage for example by increasing the pressure across each ejector to negate the pressure drop passing though the remainder of the stage. In some cases the pressure increase across the ejector may be greater than the pressure drop to go through the rest of the stage—which results in a net pressure increase across a stage. Extending this, if the conditions (e.g. relative liquid to vapor flow rates) are correct pressure can be added across multiple stages to generate an overall pressure increase through the entire unit. The overall pressure increase refers to the discharge pressure of a gas phase as an exit stream when compared to a gas stream pressure at an inlet to the system.

If the system itself has heat addition equipment or if an external source of heat is available this heat may be employed in a system of the invention. For example in a distillation configuration including a reboiler and a condenser it may be possible to use the higher pressure gas leaving the system (as described above) as the source of energy to the reboiler. In other words the higher pressure gas can be employed in a heat pump arrangement. The higher pressure vapour can be employed as the source of heat for the reboiler as it will condense at a higher temperature than the temperature required to cause boiling in the reboiler. This principle is employed for example in multi-effect evaporator systems.

The purpose of the recycle loops 19b,39b provides the ability Lo create the correct liquid to vapour ratios to allow pressure increase.

As discussed above the recycle loops 19a and 39a allow recycle to the separators. These recycle loops form part of a pump protection system to ensure the pump does not “dry run”. Secondly they allow for maintenance of a liquid level in the separator (cyclone) which can be desirable.

It is possible also to recycle the gas phase in an analogous fashion. However, generally speaking this may not be an economical proposition since compression may be required. If however the volume of liquid in any system was substantially greater than the volume of gas it may be more cost effective to compress the gas as compared to pumping the liquid.

FIG. 2 shows an alternative configuration of a system of the present invention. In particular the configuration shown in FIG. 2 is the configuration normally referred to is as a “stripper”. The system does not contain a condenser and a vapour stream is “stripped” off—hence the name for the configuration. In particular the system has a first downstage mass transfer and separation module 201 and a second upstage transfer and Separation module 202. The two separate modules are connected in series.

The downstage module 201 has a fluid intake 203a, 203b which is formed as part of an ejector 204. The fluid intake 203a receives fluid from module 202 while fluid intake 203b receives fluid from reboiler 214. As described previously the pressure of the fluid from intake 203a may be used to suck in fluid from intake 203b. The fluids from the separate intakes arc combined on ejection. The ejector 204 is connected by a conduit 205 to a mixing unit 206. The mixing unit 206 is connected in turn by a conduit 207 to a separation chamber 208. The separation chamber 208 has a first fluid outlet 209 and a second fluid outlet 210. A pump 211 is provided which can pump the second fluid phase taken off through outlet 210 via three alternative routes namely a recycle loop 212, via a conduit 213 to be taken off from the system or alternatively via conduit 215 to reboiler 214. From the reboiler 214 the fluid is passed via conduit 216 to fluid inlet 203b of ejector 204. Again the recycle loop 212 may he employed to stop the pump 211 from running dry.

The upstage module 202 has a fluid intake 220a and 220b formed on an ejector 221. As in the module 201 and the modules of previous configurations the ejector 221 is in sequence with a mixing unit 223 to which it is; connected by a conduit 222 so that fluid can pass from the ejector to the mixing unit. The output from the mixing unit 223 is passed into a separation chamber 225 via conduit 224. As for previous configurations a pump 227 is connected by a conduit 226 to the base 228 of the separation chamber 225 A recycle loop 229 is provided as before. The recycle loop 229 may, as with all the recycle loops described herein can be used to stop the pump employed from running dry. A main return conduit 230 which returns fluid from the pump to the fluid inlet 203a of the injector 204. The main feed stream is labeled 231 and is fed directly into the fluid intake 220a of the upstage module 202. The second fluid output 232 from the separation module 225 may be used to strip off a fluid phase from the system as illustrated. The separate feeds are mixed to an extent in the ejector 221.

It will be appreciated that the fluid intake 203a for the downstage module 201 is in fluid communication with one of the fluid phase outlets (outlet 226) of the upstage module 202 so that a fluid phase from the upstage module 202 is fed into the fluid feed 203a for the downstage module 201. The fluid intake 220b for the upstage module 202 is in fluid communication with one of the fluid outputs (209) via conduit 217 from the downstage module 201. Fluid from the downstage module 201 is thus fed into the fluid stream for the upstage module 202.

As for the previous embodiment the mass transfer of fluid from one phase to the other occurs through intimate mixing of fluid streams which are at different temperatures and which contain different relative amounts of the components to be separated>Mass transfer of the mass transfer component is effected in the ejector and normally to a greater extent a mixing unit.

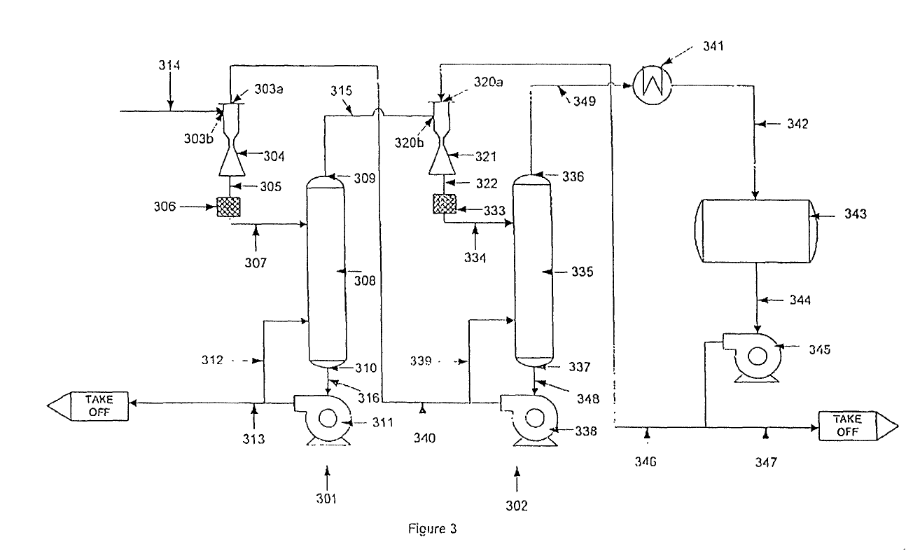

FIG. 3 shows a configuration of a system of the present invention which acts as a rectifier. The rectification system of FIG. 3 comprises a downstage module 301 and an upstage module 302. The downstage module 301 has two fluid intakes 303a, 303b which form part of an ejector 304. The intake 303a receives a fluid phase from module 302, while intake 303b receives a fluid from feed 314. The ejector 304 is connected by a conduit 305 to a mixing unit 306. The mixing unit 306 is, in turn, connected by a conduit 307 to a separation chamber 308. The separation chamber 308 has a first fluid outlet 309 for a first fluid separator in the separation chamber, and the second fluid outlet 310 for a second phase separated in the separation chamber 308. The outlet 309 provides fluid via a conduit 315 to intake 320b or module 302 The fluid outlet 310 is connected via conduit 316 to a pump 311 from which it can be transferred to a recycle loop 312 or taken off via conduit 313 as indicated. The fluid inlet 303b of ejector 304 receives a main fluid feed via conduit 314.

The intake 320a receives fluid from module 302 while intake 320b receives fluid from module 301. The dual intakes 320a and 320b supply the fluids to the ejector 321 in a manner analogous to that described above.

The upstage module 302 has fluid intakes 320a and 320b formed as part of an ejector 321. A conduit 322 links the mixing unit 333 to the ejector 321. The fluid which passes through the mixing unit 333 passes via conduit 334 into a separation 335. The separation chamber 335 has a first fluid outlet 336 and a second fluid outlet 337. Fluid from the second fluid outlet 337 passes via conduit 348 to a pump 338 where it can be recycled through recycle loop 339 or returned via conduit 340 to the fluid intake 303a of the ejector 304.

The fluid which passes through outlet 309 may, as indicated, be input into ejector 321 via inlet 320b. Fluid from outlet 336 is passed, as indicated via conduit 349 through a condenser 341 where it is condensed and passed via conduit 342 to an accumulator 343 where it may be stored. If desired fluid could be taken off from the accumulator as a vapour. In this latter arrangement the condenser 341 may represent a partial condenser. Alternatively fluid may he taken off via conduit 344 and pumped via pump 345 via a return conduit 346 to fluid inlet 320 of ejector 321. Fluid may alternatively or additionally be taken off via conduit 347 as for previous embodiments. The fluid intake 303 for the downstage module 301 is thus in fluid communication with one of the fluid phase outputs from the upstage module 302 so that a fluid phase from the upstage module 302 is fed into the fluid feed for the downstage module 301. The fluid intake for the upstage module 302 is in fluid communication with one of the fluid outputs from the downstage module so that fluid from the downstage module 301 is fed into a feed stream for the upstage module 302. Again effective mass transfer is achieved through intimate mixing of fluid streams which are at different temperatures and which contain different relative amounts of each of the fluid phases.

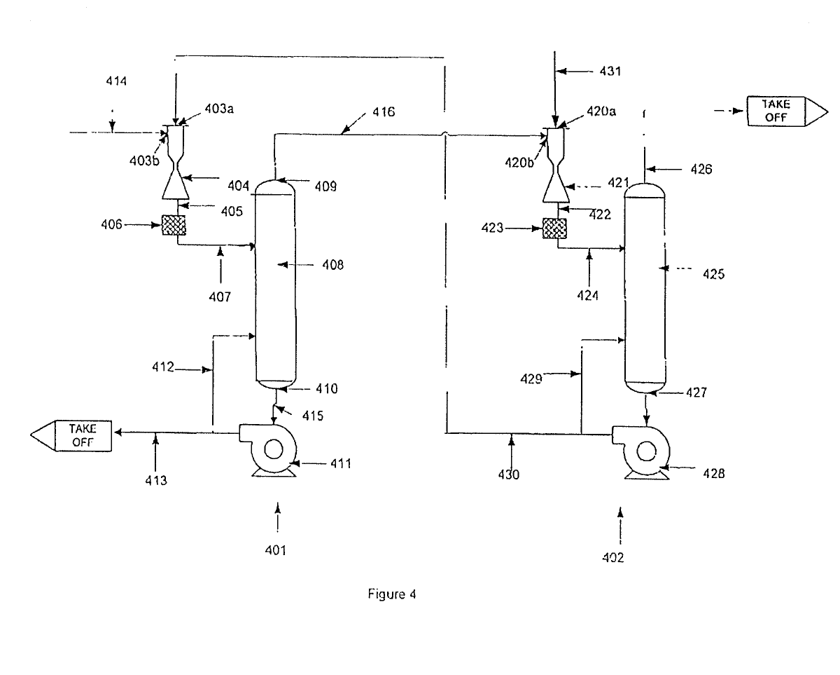

FIG. 4 shows a configuration of the system of the present invention which may be termed a “contactor”. In the embodiment a downstage module 401 and an upstage module 402 are provided and are connected in series. It will be noted that as described above no heat input or extraction is necessary (but it will be appreciated that for certain applications heat input or extraction is desirable) so that the system does not have a reboiler or condenser.

The downstage module 401 has a fluid intake 403a, 403b formed as part of an ejector 404. Intake 403b receives a feed stream (of stock fluid) from conduit 414. Intake 403a receives a fluid from upstage module 402. The arrangement of the intakes 403a and 403b is analogous to that described for the intakes of ejectors of previous embodiments. The ejector 404 is connected via conduit 405 to the mixing unit 406. The mixing unit 406 is connected via conduit 407 to a separation chamber 408. The separation chamber 408 has a first outlet 409 for a first phase and a second outlet 410 for a second phase. The fluid from the outlet 410 may be pumped via conduit 415 by pump 411 through a recycle loop 412 or taken off via conduit 413. The outlet 409 is connected via conduit 416 to intake 420b. A main fluid reed 414 is fed into the intake 403b of the ejector 404.

The upstage module 402 has a fluid intake 420a, 420b on an ejector 421. The intake 420b receives fluid from module 401 while intake 420b receives a separate fluid feed 431. The intakes are arranged as described for other embodiments. The ejector is connected via conduit 422 to a mixing unit 423. The mixing unit 423 is connected via conduit 424 to a separation chamber 425. The separation chamber 425 has a first outlet 426 for a first phase arid a second outlet 427 for a second phase. A pump 428 may pump fluid from the outlet 427 via a recycle loop 429 back into separation chamber 425 or via a return conduit 430 to fluid intake 403. The fluid output from outlet 426 may be taken off as indicated.

A lean contact stream 431 is input into ejector 421. The contact stream 431 may be used to strip from the main fluid feed 414 (which has been processed by module 401) undesired components. For example contact stream input 431 may be an amine liquid, while the main fluid feed 414 could feed a naturally occurring hydrocarbon, so that the amine removes undesired components from the hydrocarbon stream as described above. The contacting is done so that the feed amine stream—referred to as a “lean” stream as it is lean of other components, contacts fluid from the main feed stream 414 that has already been processed by the downstage module 401. The configuration ensures that fluid contacted with the lean amine stream can be recycled to the downstage module 401 where it meets and undergoes mass transfer with the main fluid feed 414.

It will be noted that in each of the embodiments described above the fluid inlet for each module receives a pressurised fluid feed, in each configuration from a pumped feed.

FIG. 5 shows a system of configuration of an ejector, a mixing unit in particular a static mixer, and a separating chamber in particular a cyclone separator which may be used in the present invention. An ejector 450 has an intake end 451 and an outlet end 452 with an intermediate elongate hollow body 453 and an ejector nozzle 459. On the intake end 451 of the ejector nozzle 459 is a first intake port 454 and a second intake port 455, both of which arc for feeding fluid to the ejector. These ports correspond to the intakes identified on each of the ejectors described in the embodiments of FIGS. 1 to 4 and 12. In particular, fluid coming to the ports 454 and 455 are mixed in the hollow body 453 by using low pressure generated by pressurised fluid passed into ejector nozzle 459 via port 454 to suck in fluid though port 455. Three flanges 456, 457 and 458 are respectively provided about ports 455 and 456 and at the outlet end 452. The flanges 456-458 are conventional, allowing the ejector to be connected to other components as desired. The ejector is connected in turn by flange 458 to a static mixer 480. The static mixer 480 has an elongate body 481 provided at its top end with al flange 452 which is connected to the flange 458 or ejector 450. Also provided at the lower end of the elongate body is a flange 483 which is connected in turn to an inlet for cyclone separator 500.

The cyclone separator 500 comprises a cylindrically-shaped vessel 501 with closed rounded (“bell”) ends which forms the body of the separator. The separator has a first (top) end 502 and a second (bottom) end 503. The separator 500 has a fluid intake in the form of an elbow pipe 504 which forms a tangential fluid entry port for the cyclone separator. The elbow pipe 504 is for communicating pressurised fluid into the interior of the separator. The elbow pipe has a flange 505 which in the embodiment is shown directly connected to the flange 483 of the static mixer 480. At the first end 502 of the separator is an outlet in the form of a port 506 which is provided with the flange 507 for easy connection to other pieces of equipment. Also provided on the second (bottom) end 503 of the separator is an outlet in the form of a port 508. The outlet port 508 is provided with a flange 509 for connection to other pieces of equipment. A further port 510 is provided at the bottom end of the separator which may be used for recycling of fluid. It is, provided with a flange 511. The outlet ports 506,508 are respectively arranged to collect a first and second phase separated in a vortex of the fluid which is created by the vessel. The ports communicate the respective fluids to the exterior of the vessel. Also provided is an external recycle pipe 512 which forms part of a trap and recirculation system which will be described in more detail below.

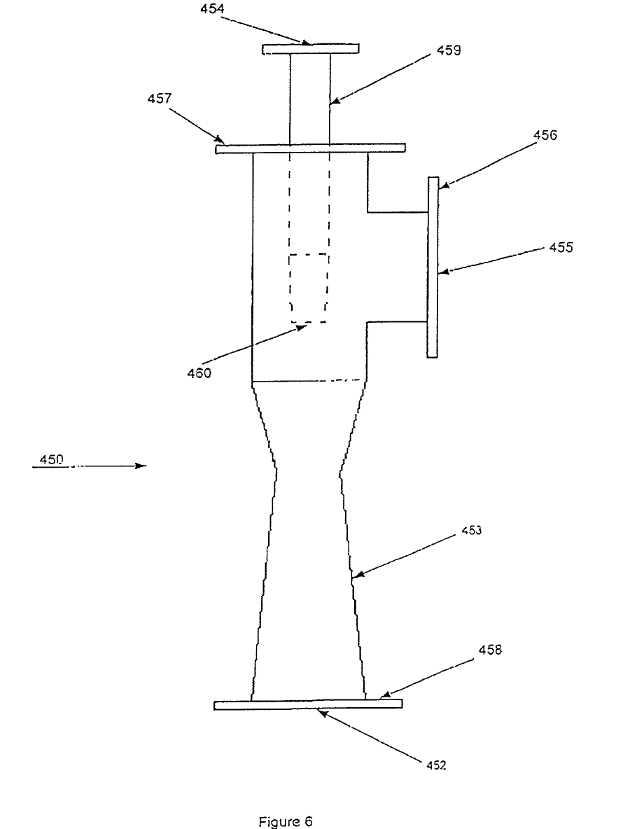

FIG. 6 shows a part-sectional view of the ejector 450 described earlier with respect to FIG. 5. The ejector 450 is provided with an ejector or spray nozzle 459 which takes fluid through intake port 454 which is under pressure and ejects it through its nozzle tip 460 in the form of mist or spray normally as a conical spray. The spraying action creates a low pressure causing sucking in of fluid through port 455.

FIG. 7 shows a part-sectional view of a mixing unit 480 with a baffle in the form of a mixing element 520 which is diagrammatically represented. The mixing element 520 is normally housed in the static mixer 480, in particular it is held in the elongate body 481 mixer by an s-shaped retaining member 529 shown in the underneath view of FIG. 7a of the static mixer. The mixing element 520 is shaped to cause intersecting fluid flow.

In particular the mixing element 520 has seven distinct sections 522-528 each of which contains a number of vanes 521 arranged in different orientations to ensure that fluid flow across the mixing element effects thorough mixing of the fluid as fluid passes through the mixing unit 480 from one end to the other.

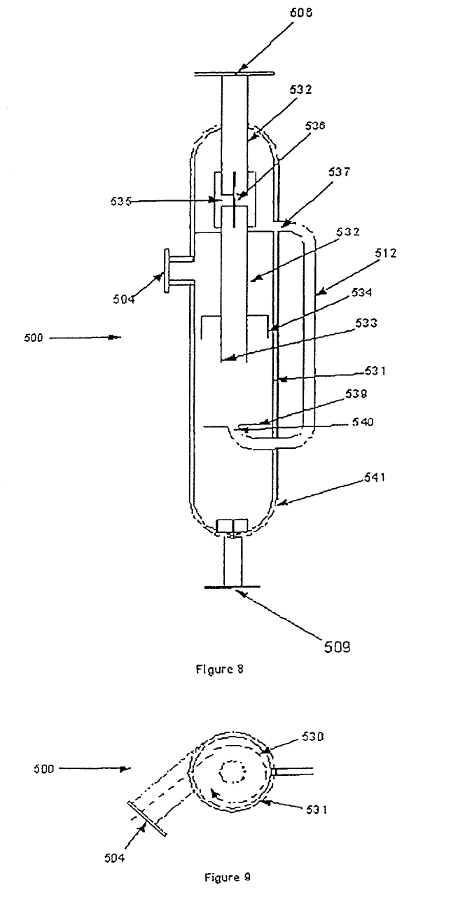

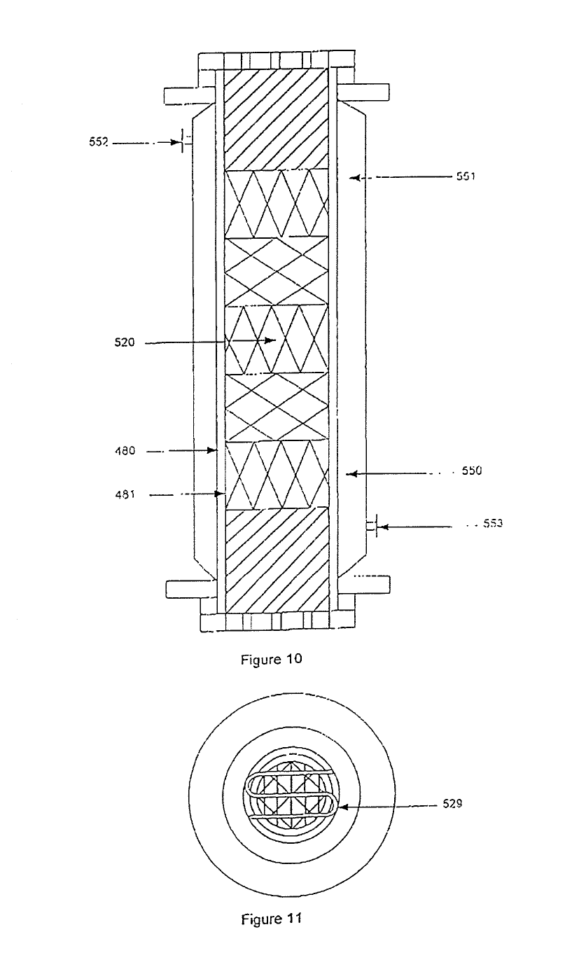

FIGS. 8 and 9 show further detail of the cyclone separator 500. The pipe 504 forms a fluid intake for communicating pressurized fluid (from the static mixer 480) into the interior of the cyclone separator. The broken line 530 indicates the trajectory of the fluid communicated to the interior of the vessel. In the embodiment, at least part of the internal wall surface 531 forms an interior circulatory surface so that fluid communicated into the vessel whirls about the inner wall 531 of the vessel creating a vortex. The vortex (cyclone) effects separation using centrifugal/centripetal forces to effect separation. In the embodiment the fluid intake for the separator imparts the tangential trajectory to the pressurised fluid. In an alternative embodiment, the fluid intake for the cyclone separator 500 could be arranged to impart a trajectory to the fluid which aligned axially with the elongate axis of the cyclone. In this latter embodiment the tangential trajectory may be provided by passing the pressurised fluid over one or more vanes which are arranged to impart the desired trajectory. As can be seen from FIG. 8, the interior circulatory surface is formed in part by a separate component in the form of an elongate tubular element in the form of a hollow tube 532. The tube 532 is mounted centrally in the cyclone 500. The tube 532 acts to take up the fluid phase at the centre of the vortex and to communicate it toward the outlet port 506. The fluid phase will continue to vortex at least part of the way up the interior wall 533 of the tube 532. An inverted cylindrically-shaped baffle 534 with a closed lower end is provided about the elongate tube 532 to aid in prevention of the denser fluid from travelling up with the vortex towards the top of the separator 500. In the embodiment shown an aperture in the tubular body of the tube 532 is provided. The aperture 535 takes the form of a break in the tube 532. The elongate tube 533 continues upwardly towards the top of the separator being integrally formed with the outlet port 506. A support rod 536 connects the two parts of the tube 532.

As can be seen from FIG. 8, the (exterior) recirculation tube 512 has an intake port 537 close to the gap, or break, 535. The recirculation tube 512 extends downwardly and reenters the separation chamber and continues inwardly to the point where it meets a baffle plate 539. The tube 512 is arranged so that the outlet port 540 opens at the centre of the baffle plate 539. The outlet port 540 is thus exposed to the low pressure at the centre of the vortex creating a suck-back through recirculation tube 512. This arrangement provides a trap for denser fluid to travel out of the elongate hollow tube 532 and into the recirculation tube. In this way the denser fluid travelling with the vortex can be returned to the base of the vortex to undergo the separation process once more. In the arrangement where a liquid and gas are being separated by the vortex the gas will travel out of outlet port 506 and the fluid will collect at the base 541 of the separator which may be designed to collect the liquid.

FIGS. 10 and 11 show a mixing unit in the form of a static mixer which has been jacketed to allow for heat exchange for supply of heat energy to or for removal of heat energy from the mixing unit as required. It will be appreciated by those skilled in the art that the intimate mixing achieved within the mixing unit will allow for effective and efficient heat transfer to or from the fluid in the mixer.

In particular the mixing unit 480 is identical to the mixing unit of FIG. 7 having a mixing element 520 therein and accordingly the same reference numerals have been employed. On the exterior of the body 481 of the mixing unit 480 is a jacket 550 which is a heat exchange jacket for exchange of heat with the mixing unit 480. In the part sectional view of FIG. 10 the jacket 550 is shown only on two sides of the mixing unit. It will be appreciated that the jacket may envelope the mixing unit. The jacket can envelop all or part of the mixing unit as desired. The jacket 550 is in the form of a hollow body 551 which is arranged to contact a heat exchange fluid with the body 481 of the mixing unit. In particular the jacket 550 is provided with two ports 552 and 553 which can be used for intake or output of heat exchange fluid to the hollow body 551 as desired. The jacket 550 can thus be used to heat or cool a fluid in the mixing unit. An underneath view of the jacketed mixing unit is shown in FIG. 11. An s-shaped retaining member 529 is employed to retain the mixing unit in the mixing unit body 481. Alternatively or additionally the baffles could comprise a heat exchanger—for example the baffles could be hollow forming, one or more conduits through which a heat exchange fluid can be passed. Heat transfer across the baffles in thus possible.

### Experiments

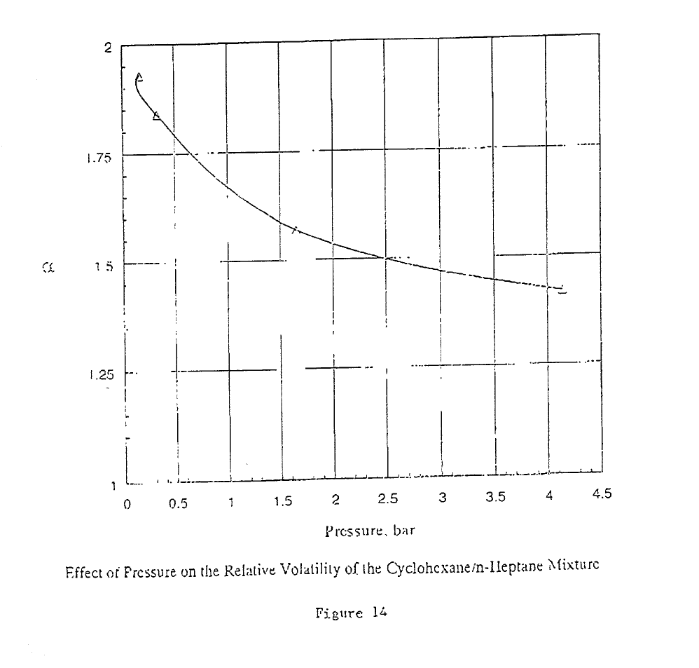

A series of total reflux distillation tests were carried out by incorporating a system according to the present invention within a distillation system as shown in FIG. 13. The system was supported by existing reboiler, condenser, process instrumentation and control system. As shown in FIG. 13 the system studied in this work comprised six cells, or stages. Each cell contained a co-current flow mixing section, either a static mixer or an ejector (eductor), paired with a cyclone-type separator for a liquid-vapor mixture. Pumps were used to move the liquid from stage to stage, against the pressure gradient of the flowing vapor. The system was tested with a static mixer or an ejector (eductor) as the mixing element. A combination or both a static mixer and in eductor working together is thought to be even more efficient in terms of the separation achieved.

The configuration of FIG. 13 includes the following components:

| | |
|---|---|
| V-701 to V-706 - cyclone separators | T-701 to T-706 - recycle valves |
| T708 - temperature indicator this is | H-102 - reboiler |
| labelled but not shown | |
| PT202 - steam pressure transmitter this is | FC202 - is steam to reboiler flow control |
| labelled but not shown | valve |
| T202 - steam temperature indicator this is | P-01-701 to P-01-706 - pumps |
| labelled but not shown | |
| T203 - temperature of condensed steam | PC215a - pressure control valve for vent |
| this is labelled but not shown | |
| C-102A-DI - Vacuum pump | P-101-CW - Cooling water for condenser |
| | pump |
| V-103 - tank | |
| PC215b - nitrogen feed valve | T224 - Cooling water temperature to |
| | condenser this is labelled but not shown |
| F - flow meter (two one water cooling flow | T226 - Cooling water temperature from |
| other steam flow) | condensor this is labelled but not shown |
| T216 - Vapor condensor this is labelled | H-104 - Condensor |
| but not shown | |
| T225 - liquid from condensor this is | PT2071 - pressure of condensed liquid this |
| labelled but not shown | is labelled but not shown |
| V-102 - reflux vessel | T2071 - temperature condensed liquid this |
| | is labelled but not shown |
| LT206 - level of reflux vessel this is | LCV-206 - reflux level control valve |
| labelled but not shown | |
| P-102 - condensor reflux pump | Shown but not labelled are: Ejectors/static |
| | mixers (in the configuration represented as |
| | independently selectable) |
| Not labelled but shown are 5 valves for | PT707 is a pressure transducer |
| flow control (they appear on pump | |
| discharge to ejector line for pumps P-01- | |
| 702 to P-01-706) | |

The mass transfer performance of the six-cell system was characterised using a cyclohexane/n-heptane test mixture (a 50/50 mixture). In the static mixer configuration, four operating pressures were studied: 0.165, 0.33, 1.65 and 4.14 bar. In the eductor configuration, two operating pressures were studied: 0.33 and 1.65 bar (The static mixer and the eductor were independently operable)

The objectives of the study were to

Determine the effect of mixing geometry and physical properties on mass transfer, pressure drop and hydraulic capacity of the system.

Determine whether the system of the invention would work

Determine whether the cell/stage efficiencies approached 100%

Determine whether the system employing eductors could provide a net pressure increase

Determine whether the system was operationally stable and could be controlled

Compare mass transfer capability to existing technologies

Compare the physical size of the system of the invention to that of existing technologies

Fiberglass insulation was used on the system of the invention. Calcium silicate insulation was utilised on the existing distillation equipment.

A Delta-V hardware control system was used. Vapours leaving cell #6 rose to a condenser, and condensate was returned to the middle of the distillation column through a side nozzle. The returned liquid to the column was not fed through a distributor in order to minimise any mass transfer occurring in the column. The liquid feed rate to the system was maintained through level control of the column bottoms. The flows to and from each cell were maintained by controlling the levels in each cell. A sight glass at the bottom of each cyclone allowed observation of each level. Needle valves on the recycle and transfer lines between cells allowed for control of each level. The liquid level was controlled manually.

The reboiler was heated with 83.3 bar steam and the condenser was cooled with 10° C. chilled water. In these runs, the reflux was returned to cell #6 by pumping from the bottom of the distillation column. The vapour from the reboiler was fed to the mixing section of cell #1. The liquid leaving cell #1 was returned to the reboiler.

Pressure drop data were measured using a commercially available differential pressure cell (DPC) designed for ranges of 0-150 inches of water. Both the high and low-pressure legs of the cells were purged with nitrogen to prevent hydrocarbon condensation. Pressure drop was measured across the entire system. A check of the differential pressure transmitter was determined from the reboiler return pressure and the column pressure. A second differential pressure transmitter was available to measure pressure drop across a single cell.

To minimise end effects, liquid samples were collected from the column bottoms pump that fed reflux to the system and from the pump that fed liquid to the reboiler. Temperatures were measured of the liquid exiting each cell.

After system installation and pressure testing of the entire distillation system were completed, the binary test mixture of cyclohexane and n-heptane was pumped to the bottom of the distillation column and reboiler as an initial charge. The system was then started by admitting steam to the reboiler under duty control, at a heat duty of 0.1 million BTUs per hour. The system pumps are started once the vapour reached cell #6. The cyclone liquid level was controlled by manually adjusting the liquid recycle and transfer needle valves. The level in cell #6 was controlled first, followed by cell #5, then cell #4, and so on. In general, once these levels are set at a given heat duty, they require very little attention until the next change of heat duty. Thus the liquid/vapour ratio L/V remains constant with a value of unity.

Once the cell liquid levels were set, the system was operated for two hours before the first sample is taken. Samples were then taken at forty-five minute intervals to ascertain that steady state had been achieved.

Samples were analysed by gas chromatography using a TCD detector; each sample was processed at least twice through the chromatograph. Standards for calibration of the chromatograph were prepared gravimetrically. Separate calibrations were made for the cell#1 and reflux composition ranges. A program in the integrator selected the appropriate calibration curve for the composition range when a sample was processed.

For the static mixer case, four operating pressures were studied; 0.165, 0.333, 1.65 and 4.14 bar. For the eductor case, two operating pressures were studied: 0.333 and 1.65 bar.

The dimensions of the static mixer are given in Table 1. Dimensions of the cyclone are given in Table 2.

TABLE 1
Static Mixer Geometry

| Vendor | Sulzer |
|---|---|
| Model | 6080-5V |
| Diameter (o.d.), cm | 7.80 |
| Length, cm | 26.4 |
| Material of Construction | 316 SS |
| Design DP (bar) @ Ug = 8.75 m/s | 0.020 |
| Estimated DP (bar) @ U_{g} = | 0.115 |
| 0.75 m/s and U_{L} = 0.13 m/s | |

TABLE 2
Cyclone Dimensions

| | |
|---|---|
| Cyclone Diameter (i.d.), cm | 15.4 |
| Cyclone Height, cm | 87.6 |

The mass transfer results are represented as a stage efficiency (Eₒ) calculated from the total number of equilibrium stages of separation achieved relative to the number of cells. At total reflux, the Fenske equation may be used to calculate the number of stages, based on distillate and bottoms compositions:

$${N}_{S} = \frac{ln \{ ( \frac{{X}_{D , C6}}{{X}_{D , C7}} ) ( \frac{{X}_{B , C7}}{{X}_{B , C6}} ) \}}{ln \{ α \}}$$

$${E}_{O} ( \% ) = \frac{{N}_{S}}{6} \cdot 100$$

where

X_{D, C6}=mol fraction of cyclohexane entering cell#6

X_{D, C7}=mol fraction of heptane entering cell#6

X_{B, C6}=mol fraction of cyclohexane entering cell#1

X_{B, C7}=mol fraction of heptane entering cell#1

α=average relative volatility

The average relative volatility was determined using a geometric average based on the pressures in cell #1 and cell #6.

α_{avg}=\sqrt{α_{Pcell #1}·α_{Pcell #2}}

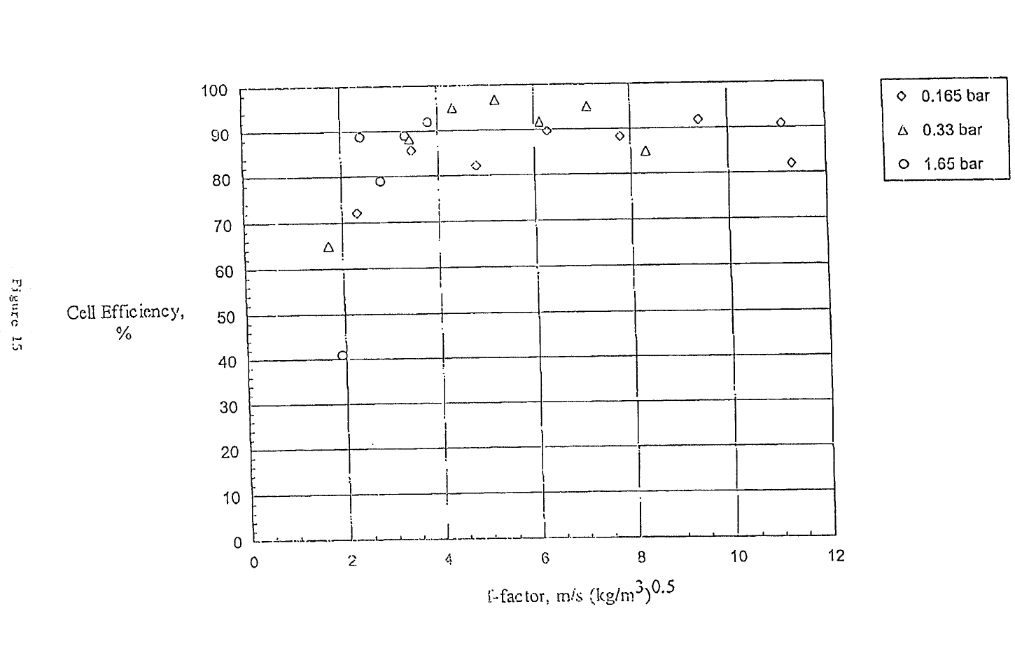

A plot of the relative volatility versus pressure is given in FIG. 14. Physical properties of the test mixtures are given in Table 3.

The cell efficiency is plotted against a term referred to as an F-factor. This independent variable is based on the cell #6 operating conditions and is defined as:

F_{FACTOR}=Uₛ\sqrt{ρᵥ}

where

Us=superficial vapour velocity based on the cyclone inner diameter, m/s

r_{L}=liquid density, kg/m³

rᵥ=vapour density, kg/m³

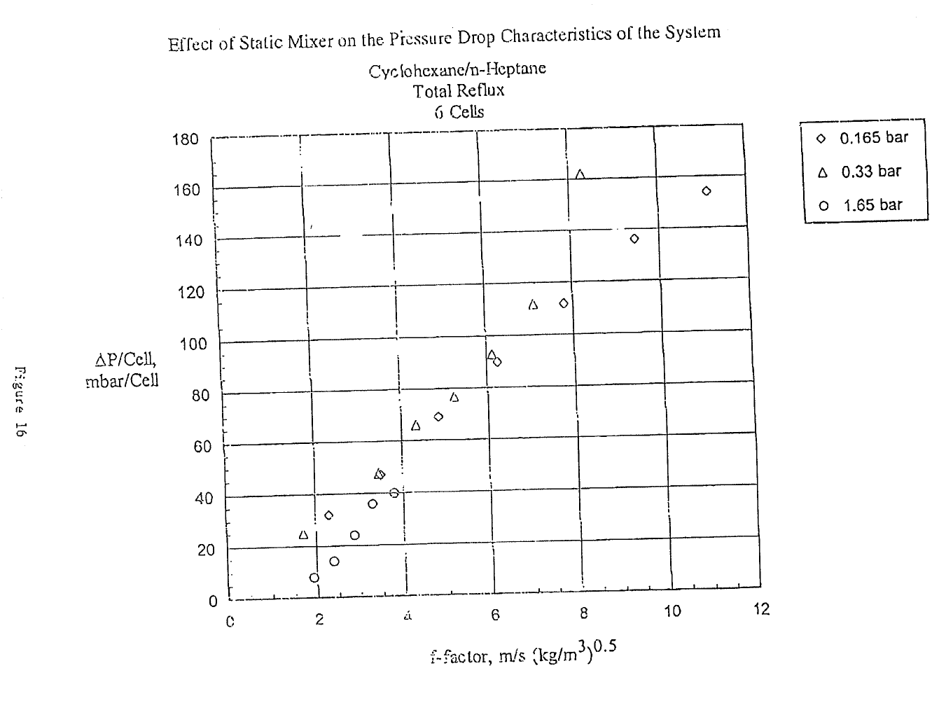

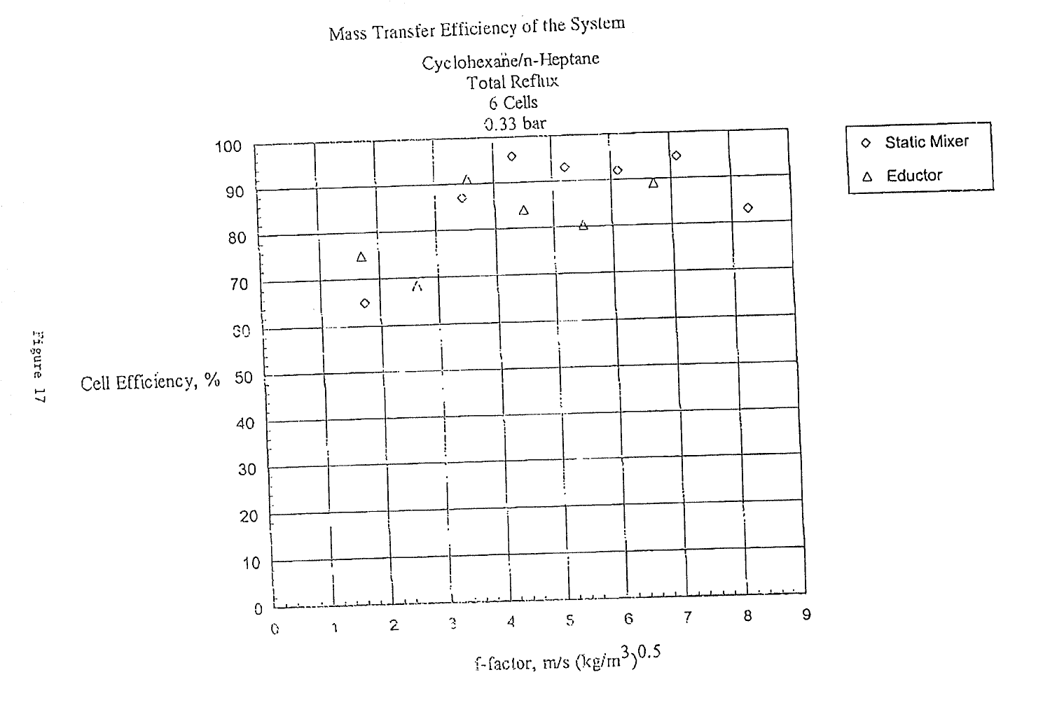

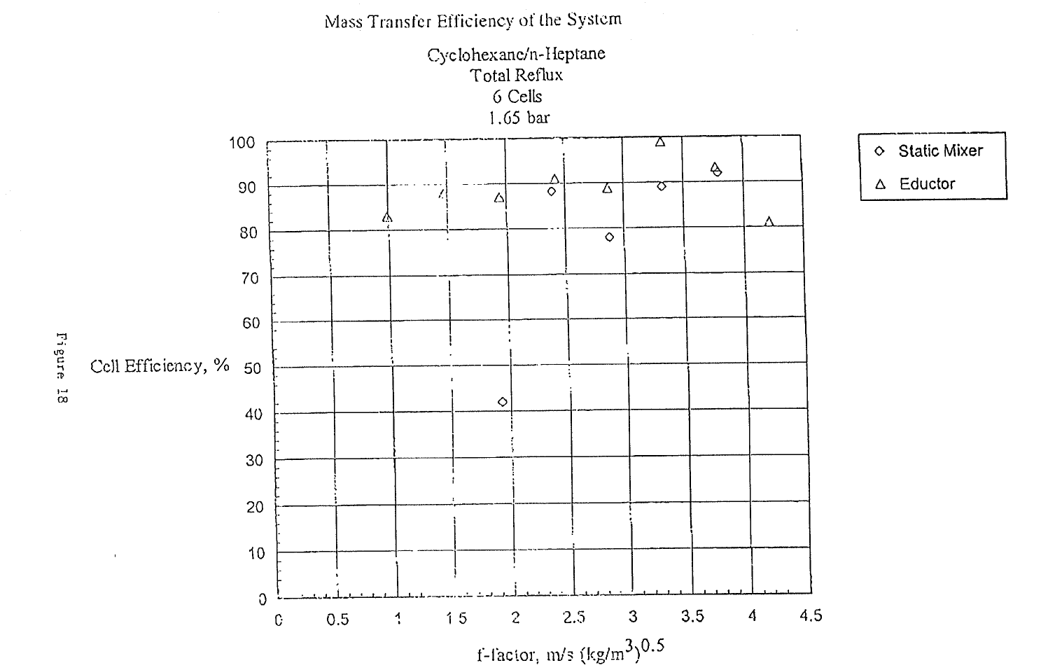

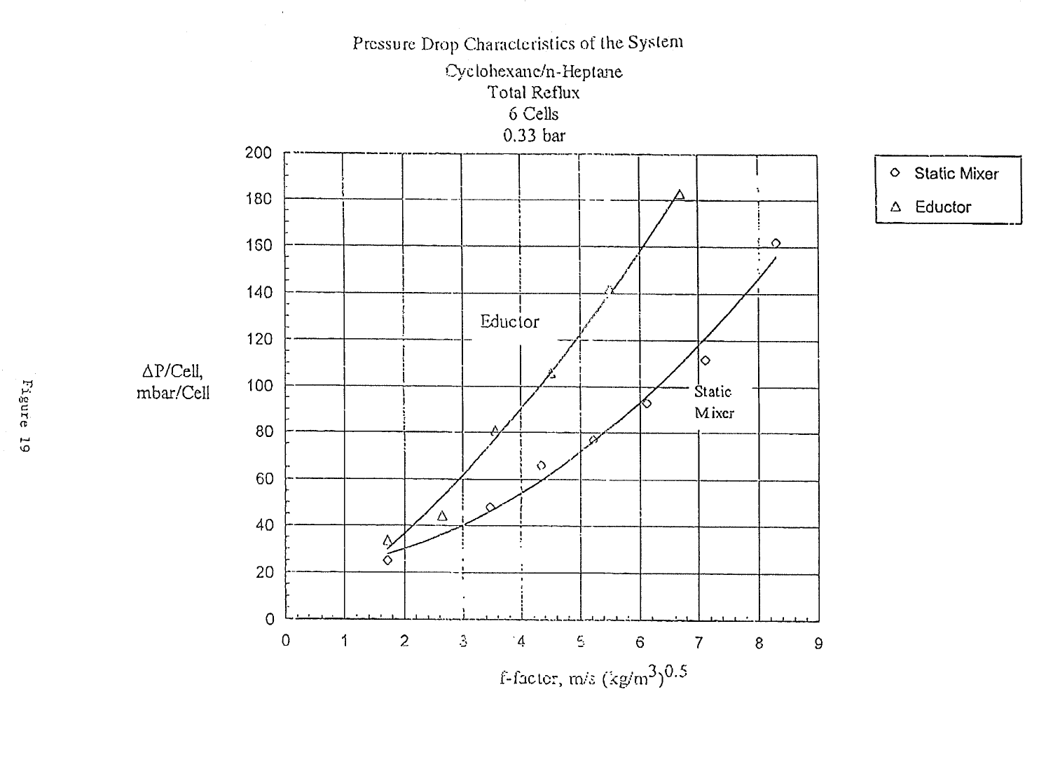

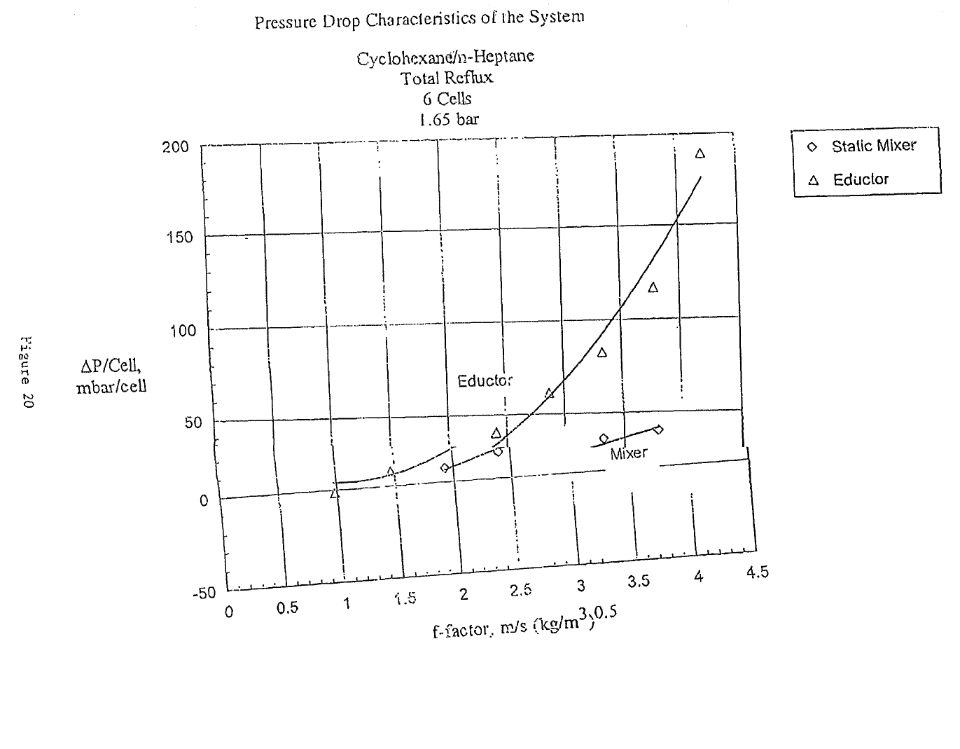

Distillation mass transfer and pressure characteristics of the static mixer system are given in FIGS. 15 and 16. Comparative distillation mass transfer and pressure characteristics of the eductor system arc given in FIGS. 17-20.

TABLE 3
Physical Properties of the Cyclohexane/n-Heptane System
(Average at Column Bottom)

| Pressure (bar) | 0.17 | 0.33 | 1.65 | 4.14 |
|---|---|---|---|---|
| Liquid density, kg/m³ | 659 | 657 | 608 | 561 |
| Liquid viscosity, kg/m-s | 1.68 | 1.55 | 1.35 | 0.58 |
| Liquid diffusivity, m²/hr | 8.3E−6 | 9.8E−6 | 2.2E−5 | 3.3E−5 |
| Vapour density, kg/m³ | 0.66 | 1.19 | 5.44 | 13.14 |
| Vapour viscosity, kg/m-s | 0.024 | 0.025 | 0.03 | 0.033 |
| Vapour diffusivity, m²/hr | 0.048 | 0.041 | 0.011 | 0.005 |
| Surface tension, dynes/cm | 18 | 17 | 14 | 8 |
| Relative volatility | 1.94 | 1.86 | 1.57 | 1.42 |
| Slope of equilibrium line | 1.54 | 1.5 | 1.35 | 1.32 |
| Average Temperature, ° C. | 49 | 61 | 114 | 154 |

### ANALYSIS OF RESULTS

The performance of the system is surprisingly good on a prototype system. In general, cell or stage efficiencies ranged between 70 and 98%. Most of the efficiencies were in the 90-98% range. Typical efficiencies of conventional sieve trays range from 60-70%. The f-factor obtained by the system typically ranged from 2-8 m/s (kg/m³)^{0.5} as compared to previous sieve tray studies where the f-factor ranged from 0.5-2. It should be noted that the system design studied in this work was not optimized. It is very likely than an improved design that minimized pressure drop and included larger pumps could achieved higher f-factors. The system with its six 6-in diameter hydrocyclones occupied a space of 13.5 ft (H)×6.4 ft (W)×8 ft (L). Conservatively, this would compare to a sieve tray column that occupies a space of 1.2 ft (D)×40 ft (H). Thus, the system will occupy considerably less space and weight.

AS anticipated, the high efficiency associated with the small equipment and short residence times came at the expense of pressure drop. This should be expected since a high vapor velocity is needed to atomize the liquid into fine drops that in turn provide a high interfacial area for mass transfer. The cyclone appeared to have little trouble separating the liquid from the vapor. The high efficiency at the high rates suggests that little or no liquid entertainment occurred. The throughput of the 3C Unit was limited by the interstage pumps' ability to overcome the cell pressure drop. Thus the capacity of the system could be increased with pump modifications and/or changes that reduce pressure drop.

While not quite as efficient, the eductor system provided a wider operating range relative to the static mixer system. Conversely, the pressure drop of the eductor system was higher. However at 1.65 bar, the eductor actually provided a slight pressure rise across the system at an f-factor of 1.0 (liquid rate=725 lbs/hr). It should be noted that occasional checks showed that each cell, during either the static mixer or eductor runs, provided essentially uniform pressure drops. Thus, the high overall pressure drop could not be attributed to line blockage or problem with one individual cell or process line.

The system provided little or no control problems. Generally, once the levels in each cyclone are set, they require little attention. Only the level in cell #6 appeared to fluctuate as a result of fluctuations in the distillation column level. The system took longer to reach steady state than anticipated. This may be a result of added time required to reach thermal equilibrium because of heat loss.

The actual design of the system could be configured in some cases to induce a pressure rise (for example with an eductor). Data obtained at 4.14 bar are not presented in this report because of the problems associated with the system heat loss as well as pump limitations. The elevated temperature associated with the 4.14 bar runs resulted in significant heat loss at reboiler duties less than 0.2 MM BTU/hr. At this duty and lower, a large percentage of the vapour generated by the reboiler condensed in the unit. Because of pump limitations, we were not able to operate above a heat duty of 0.2 MM BTU/hr. The fiberglass insulation associated with the current configuration could be replaced with calcium silicate insulation in order to carry out the 4.14 bar runs.

Visual observation of the vapour/liquid contacting within the cyclone indicated a great deal of turbulence. This turbulence undoubtedly contributes to the overall mass transfer within the cell or stage. It is difficult to distinguish where the majority of mass transfer is occurring, within the mixing zone or the cyclone.

### CONCLUSIONS

The performance of the system exceeded expectations of independent testers considering that this was a prototype unit that had not yet been tested or optimised for mass transfer. Cell or stage efficiencies generally ranged between 85-95% and were independent of pressure.

Potential modifications to optimise the performance of the system include:

To minimise heat loss, calcium silicate insulation should be added.

To minimise useless pressure drop, the piping size and CV of the needle valve should be increased.

Pump capacity should be increased.

In regards to the previously stated objectives:

The test work validated the system concept

Stage efficiencies approaching 100% were achieved

A net pressure rise was observed with the eductor system at low flow velocities

Operation of the system was stable until reaching the pump limitation

Mass transfer efficiency and f-factors were superior to conventional tray or structured packing technology

The minimal size and weight of the system should be very attractive for offshore platform applications such as natural gas dehydration or carbon dioxide removal. The short residence time may provide a number of advantages especially in reducing solvent degradation at elevated temperatures. The system may also have applications where a modular unit is desired. The system should have little problem handling solids and should be cleanable with relative ease.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A mass transfer and phase separation system for a fluid comprising a mass transfer component and a second component from which the mass transfer component is separable by mass transfer the system comprising:
a first stage and at least one later stage each stage comprising:
co-current contacting means for co-currently contacting at least two fluid streams to effect mass transfer of the mass transfer component and phase separation means for separating phases from the co-currently contacted fluid streams;
the stages being in fluid communication so that at least one fluid phase obtainable by phase separation in the downstream stage is communicatable for co-current contacting and for phase separation in a later stage and at least one fluid stream which has been separated by phase separation in a later stage is communicatable for co-current contacting and for phase separation in the first stage; provided that the separation system is not a system for removing gas from a gassified liquid utlizing an inert substituting gas.

2. A mass transfer and phase separation distillation system for a fluid comprising a mass transfer component and a second component from which the mass transfer component is separable by mass transfer the system comprising:
a first stage and at least one later stage each stage comprising:
co-current contacting means for co-currently contacting at least two fluid streams to effect mass transfer of the mass transfer component and phase separation means for separating phases from the co-currently contacted fluid streams;
the stages being in fluid communication so that at least one fluid phase obtainable by phase separation in the downstream stage is communicatable for co-current contacting and for phase separation in a later stage and at least one fluid stream which has been separated by phase separation in a later stage is communicatable for co-current contacting and for phase separation in the first stage; the system utilising differences in volatilities to effect separation.

3. A system according to claim 2 incorporating at least one heat transfer step for addition or removal of heat from the system,

4. A mass transfer and phase separation contacting system for a fluid comprising a mass transfer component and a second component from which the mass transfer component is separable by mass transfer the system comprising:
a first stage and at least one later stage each stage comprising:
con-current contacting means for co-currently contacting at least two fluid streams to effect mass transfer of the mass transfer component and phase separation means for separating phases, from the co-currently contacted fluid streams;
the stages being in fluid communication so that at least one fluid phase obtainable by phase separation in the downstream stage is communicatable for co-current contacting and for phase separation in a later stage and at least one fluid stream which has been separated by phase separation in a later stage is communicatable for co-current contacting and for phase separation in the first stage; the system further comprising an intake for intake of a contacting liquid.

5. A mass transfer and phase separation system according to claim 1 wherein the first stage and the said at least one later stage is provided in modular form.

6. A mass transfer and phase separation system according to claim 1 wherein co-contacting is forcibly carried out.

7. A mass transfer and phase separation system according to claim 1 wherein the system comprises:
(i) at least two mass transfer and separation stages arranged so that there is provided a first stage and at least one later stage, each stage comprising:
(a) a fluid intake in fluid communication with, and for supplying fluid feeds containing the components to, the co-current contacting means in the form of a mixing unit,
(b) a mixing unit for mixing the components in the fluid feeds so as to effect mass transfer of the mass transfer component;
(c) phase separation means in the form of a separation chamber for separation of fluid phases for effecting separation of at least a first fluid phase and a second fluid phase from fluid received from the mixing unit;
(d) an outlet for the first phase; and
(e) an outlet for the second phase; and
(ii) a fluid communication system arranged to communicate at least one separated fluid phase from an outlet of the first stage to the fluid intake of a later stage; and for communicating a fluid phase from an outlet of a later stage to the intake of the first stage.

8. A mass transfer and phase separation system according to claim 1 wherein at least one separated fluid phase is communicated between stages without intermediate processing.

9. A mass transfer and phase separation system according to claim 1 wherein the stages of the system are provided sequentially in series.

10. A mass transfer and phase separation system according to claim 1 wherein at least two mass transfer and separation stages are connected in series so as to provide a first mass transfer and separation stage and at least one later mass transfer and separation stage; the fluid intake for the first stage being in fluid communication with one of the fluid phase outputs from a later stage so that a fluid phase from a later stage is fed into the fluid intake for the first stage; the fluid intake for a later stage being in fluid communication with a fluid output from the first stage so that fluid from the first stage may be fed into the fluid intake of a later state.

11. A mass transfer and phase separation system according to claim 1 comprising at least three stages are provided namely an n^{th} stage and at least one stage n+r and at least one stage n−s, where in n is an integer greater than or equal to 2 and r and s are each, independently of each other, an integer greater than or equal to 1 provided that n−s is at least 1, are arranged in a series so that a fluid phase output from a stage n−s or stage n is fed to a stage n+r and a fluid phase output from stage n or a stage n+r is fed to a stage n−s.

12. A mass transfer and phase separation system according to claim 1 wherein the fluid intake for at least one stage is pressurised.

13. A mass transfer and phase separation system according to claim 12 wherein the pressurised fluid is naturally occurring pressurised fluid for example a naturally occurring pressurised petroleum or gas reserve.

14. A mass transfer and phase separation system according to claim 12 wherein the fluid is pressurised to a pressure in the range from about 0.1 kPa to about 100,000 kPa.

15. A mass transfer and phase separation system according to claim 12 wherein the pressure is from about 10 kPa to about 10,000 kPa.

16. A mass transfer and phase separation system according to claim 1 wherein the fluid travels at a velocity of from about 0.1 ms⁻¹ to about 300 ms⁻¹ for example from about 0.5 ms⁻¹ to about 100 ms⁻¹.

17. A mass transfer and phase separation system according to claim 7 wherein at least one mixing unit is selected from mixing units including agitators, sprayers, spargers, static mixers, and ejectors.

18. A mass transfer and phase separation system according to claim 17 wherein at least one mixing unit is a static mixer or an ejector.

19. A mass transfer and phase separation system according to claim 18 wherein the static mixer comprises one or more baffles or vanes.

20. A mass transfer and phase separation system according to claim 19 wherein the said one or more baffles or vanes are formed by one or more mixing elements, the mixing elements being shaped to cause intimate fluid mixing.

21. A mass transfer and phase separation system according to claim 19 wherein the mixing element is an array of vanes.

22. A mass transfer and phase separation system according to claim 7 wherein at least one mixing unit is an ejector.

23. A mass transfer and phase separation system according to claim 7 wherein the mixing unit comprises an ejector and a static mixer arranged in sequence.

24. A mass transfer and phase separation system according to claim 7 wherein at least, one separation chamber effects separation using centripetal/centrifugal forces.

25. A mass transfer and phase separation system according to claim 24 wherein at least one separation chamber is a cyclone separator.

26. A mass transfer and phase separation system according to claim 25 wherein the cyclone separator comprises:
(i) a vessel with a vessel side wall, the vessel having an interior circulatory surface, and a first end and a second end,
(ii) a fluid intake for communicating pressurised fluid into the interior of the vessel tangentially to the interior circulatory surface so that the fluid whirls about the interior circulatory surface of the vessel creating a vortex and effecting separation of at least first and second phases under the forces of the vortex;
(iii) an outlet for a first phase arranged to collect a first phase separated in the vortex from the fluid and to communicate it to the exterior of the vessel; and
(iv) an outlet for a second phase arranged to collect a second phase separated in the vortex from the fluid and to communicate it to the exterior of the vessel.

27. A mass transfer and phase separation system according to claim 26 wherein the intake for the separator imparts the tangential trajectory to the pressurised fluid.

28. A mass transfer and phase separation system according to claim 26 wherein the tangential trajectory is provided by passing the pressurised fluid over one or more vanes which are arranged to impart the desired trajectory.

29. A mass transfer and phase separation system according to claim 25 wherein the interior circulatory surface is formed at least in part on a separate component within the vessel.

30. A mass transfer and phase separation system according to claim 25 wherein at least part of an interior side wall of the vessel forms the interior circulatory surface.

31. A mass transfer and phase separation system according to claim 25 wherein the cyclone separator comprises an additional recirculation path for isolating and recycling amounts of the denser phase travelling with the vortex toward the outlet for the less dense phase.

32. A mass transfer and phase separation system according to claim 31 wherein the recirculation path exposes fluid isolated in the trap to the low pressure generated at the center of the vortex to suck at least some isolated fluid back into the vortex.

33. A mass transfer and phase separation system according to claim 7 wherein a jacket is provided on at least one of the mixing units for transfer of heat to or from the system.

34. A mass transfer and phase separation system according to claim 1 wherein pressure is maintained or increased across the system.

35. A mass transfer and phase separation system according to claim 22 wherein a pressure increase is achieved by return of separated liquid to the ejector.

36. A mass transfer and phase separation system according to claim 34 wherein a gaseous phase from the system is employed to return heat to the system.

37. A method of effecting mass transfer and phase separation by distillation comprising the steps of.
(i) in a first stage co-currently contacting at least two fluid streams, the fluid streams comprising a mass transfer component, so as to effect mass transfer of the mass transfer component and separating phases from the co-currently contacted fluid streams,
(ii) in one or more later stages co-currently contacting a separated phase from the downstream stage or from any earlier stage with a fluid stream so as to effect mass transfer of the mass transfer component and separating phases from the co-currently contacted separated phase and fluid stream, and p1 (iii) transferring a phase separated in at least one later stage to the first stage for co-current contact in that stage.

38. A method of effecting mass transfer and phase separation by contacting comprising the steps of:
(i) in a first stage co-currently contacting at least two fluid streams, the fluid streams comprising a mass transfer component, so as to effect mass transfer of the mass transfer component and separating phases from the co-currently contacted fluid streams,
(ii) in one or more later stages co-currently contacting a separated phase from the downstream stage or from any earlier stage with a fluid stream so as to effect mass transfer of the mass transfer component and separating phases from the co-currently contacted separated phase and fluid stream, and p1 (iii) transferring a phase separated in at least one later stage to the first stage for co-current contact in that stage.

39. Use of a mass transfer and phase separation system for a fluid comprising a mass transfer component and a second component from which the mass transfer component is separable by mass transfer the system comprising:
a first stage and at least one later stage each stage comprising:
co-current contacting means for co-currently contacting at least two fluid streams to effect mass transfer of the mass transfer component and phase separation means for separating phases from the co-currently contacted fluid streams;
the stages being in fluid communication so that at least one fluid phase obtainable by phase separation in the downstream stage is communicatable for co-current contacting and for phase separation in a later stage and at least one fluid stream: which has been separated by phase separation in a later stage is communicatable for co-current contacting and for phase separation in the first stage; for the purpose of distillation.

40. Use of a mass transfer and phase separation system for a fluid comprising a mass transfer component and a second component from which the mass transfer component is separable by mass transfer the system comprising:
a first stage and at least one later stage each stage comprising:
co-current contacting means for concurrently contacting at least two fluid streams to effect mass transfer of the mass transfer component and phase separation means for separating phases from the co-currently contacted fluid streams;
the stages being in fluid communication so that at least one fluid phase obtainable by phase separation in the downstream stage is communicatable for co-current contacting and for phase separation in a later stage and at least one fluid stream which has been separated by phase separation in a later stage is communicatable for co-current contacting and for phase separation in the first stage; for the purposes of contacting.

41. Use according to claim 40 wherein a component from a gas stream is absorbed into a liquid steam.

42. Use according to claim 40 wherein a component from it liquid stream is absorbed into a second liquid stream.

43. Products separated by the method of claim 38.

44. Products separated by the method of claim 39.

45. Products separated by the method of claim 40.
